(19) United States
(12) Patent Application Publication
(10) Pub. No.: US 2026/0336317 A1
(43) Pub. Date: Oct. 29, 2026

(54) HEAT-SENSITIVE RECORDING MATERIAL

(71) Applicant: Koehler Innovation & Technology GmbH, Oberkirch (DE)

(72) Inventors: Timo STALLING, Appenweier (DE); Ansgar SEHLINGER, Sasbach (DE); Uwe BRASCH, Offenburg (DE)

(21) Appl. No.: 19/119,298

(22) PCT Filed: Oct. 5, 2023
(86) PCT No.: PCT/EP2023/077632

§ 371 Date: Apr. 8, 2025

(30) Foreign Application Priority Data
Oct. 11, 2022 (DE) 10 2022 126 289.8

(51) Int. Cl. B41M 5/337; B41M 5/333; B41M 5/44

(52) U.S. Cl. CPC B41M 5/3375; B41M 5/3336; B41M 5/44; B41M 2205/04; B41M 2205/36

(57) ABSTRACT

A heat-sensitive recording material may include a carrier substrate, which has a first side and a second side facing away from the first side; a heat-sensitive color-forming layer, which is arranged on the first side of the carrier substrate, wherein the heat-sensitive color-forming layer comprising at least one color former, at least one color developer, and at least one stabilizer; and an adhesive layer, which is arranged on the second side of the carrier substrate, wherein the adhesive layer comprises at least one adhesive. A weight ratio of stabilizer to color developer in the heat-sensitive color-forming layer is selected such that migration of components from the adhesive layer into the heat-sensitive color-forming layer according to a stability test after a period of two weeks leads to a remaining image stability of the heat-sensitive color-forming layer of at least 35%.

### CROSS REFERENCE

The present application is a national stage entry under 35 U.S.C. § 371 of International Patent Application No. PCT/EP2023/077632, which was filed Oct. 5, 2023, and claims the benefit of German Patent Application No. 10 2022 126 289.8, filed Oct. 11, 2022, each of which is incorporated herein by reference in its entirety.

### TECHNICAL FIELD

The present disclosure relates, according to a first aspect, to a heat-sensitive recording material comprising a carrier substrate, which has a first side and a second side facing away from the first side, a heat-sensitive color-forming layer, which is arranged on the first side of the carrier substrate and comprises at least one color former, at least one color developer, and at least one stabilizer, and an adhesive layer which is arranged on the second side of the carrier substrate and comprises at least one adhesive.

The weight ratio of stabilizer to color developer in the heat-sensitive color-forming layer is selected such that migration of components from the adhesive layer into the heat-sensitive color-forming layer according to the stability test defined in the description after a period of two weeks leads to a remaining image stability of the heat-sensitive color-forming layer of at least 35%.

According to a second aspect, the present disclosure relates to a method for producing a heat-sensitive recording material, comprising the following method steps: providing a carrier substrate, which has a first side and a second side facing away from the first side, applying an application suspension to the first side of the carrier substrate, wherein the application suspension comprises at least one color former, at least one color developer, and at least one stabilizer, drying the application suspension in order to obtain a heat-sensitive color-forming layer arranged on the first side of the carrier substrate, and applying an adhesive layer to the second side of the carrier substrate.

According to a third aspect, the present disclosure relates to a heat-sensitive recording material produceable by a method according to the second aspect.

According to a fourth aspect, the present disclosure relates to a use of at least one stabilizer and at least one color developer in a heat-sensitive recording material, comprising a carrier substrate, which has a first side and a second side facing away from the first side, a heat-sensitive color-forming layer which is arranged on the first side of the carrier substrate and comprises at least one color former, at least one color developer, and at least one stabilizer, and an adhesive layer which is arranged on the second side of the carrier substrate, wherein the adhesive layer comprises at least one adhesive.

### TECHNICAL BACKGROUND

Heat-sensitive recording materials, which are also referred to as thermal papers, are used in a variety of applications, such as sales receipts in retail stores.

Backside preparations are used in conjunction with heat-sensitive recording materials to obtain adhesive labels or thermal labels or to improve various application properties. The back preparation can be a self-adhesive layer and/or a coating (“back coat”) consisting essentially of polymeric binders and pigments.

Heat-sensitive recording materials, so-called thermal labels for thermal direct printing, equipped with a self-adhesive layer on the back are known from the prior art.

JPS 59 162 087 A, U.S. Pat. Nos. 4,370,370 A and 4,388,362 A describe thermal labels with a release paper.

DE 19 757 589 B4 describes a release paper-free (“linerless”) thermal label with a protective layer over the heat-sensitive layer.

DE19 806 433 B4 discloses a linerless thermal label with a protective layer free of silicone compounds, which was hardened using actinic radiation.

EP 0 600 622 A1 and DE 19 724 647 C1 describe a linerless thermal label with a protective layer that has been coated on the back with hot melts.

EP 1 085 069 B1 and EP 2 474 963 B1 disclose thermal label materials in a linerless design with a heat-activated adhesive, whereby thermal labels are written either with or without a protective layer.

EP 3 219 507 A1 claims a linerless thermal label without an actual protective layer, in which the surface of the heat-sensitive layer is designed to be dehesive to adhesives.

Heat-sensitive recording materials equipped with so-called “back-coat” coatings to improve the printability of the back side with conventional printing processes or to minimize the tendency of a carrier substrate to curl under unfavorable humidity conditions are also known from the prior art.

The different shrinkage behavior of the two sides of the carrier substrate of heat sensitive recording materials at different ambient humidity, i.e. with different water vapor absorption of the two sides/coats, can be effectively improved by back coatings. U.S. Pat. No. 6,667,275 B2, for example, discloses a multi-layer back coating for heat-sensitive recording materials to advantageously influence the curling tendency of the web of the carrier material.

JP 2018 167 483 discloses ways of improving the stability of the thermally generated typeface in heat-sensitive recording materials that have been coated on the back with oil-based printing inks or inks by, among other things, applying coatings to the back. The formulations of these back coatings often contain aqueous emulsion polymers, such as styrene-butadiene or acrylate latices, as an essential component.

JP 2003 175 671, for example, claims back-coatings for heat-sensitive recording materials produced with aqueous latices, which form soft polymer films (glass transition temperature≥−30 °C). JPH 0 720 735 B2 and JP 2000 204 123 disclose back-coat formulations with acrylate emulsion polymers for heat-sensitive recording materials.

Documents EP 3 957 488 A1, e.g. WO 2022/038242 A1 describe a heat-sensitive recording layer comprising phenol group-free organic color developers, a coating composition for producing the heat-sensitive recording layer and a heat-sensitive recording material, in particular thermal paper, comprising the heat-sensitive recording layer. The use of the heat-sensitive recording layer for producing the heat-sensitive recording material, a process for producing the heat-sensitive recording material and the use of the heat-sensitive recording material in thermal paper applications are also described. Due to its composition, the heat-sensitive recording material has particularly good recyclability and high environmental compatibility.

Heat-sensitive recording materials are also described in documents US 2021/0060994, CA 3 149 562 A1 and WO 2021/041600 A2.

Reference is also made to documents DE 10 2019 126 220A1, WO 2021/058661 A1, KR 2022 070 021 A, and DE 20 2020 005 616 U1.

The color-forming layer of heat-sensitive recording materials usually contains a color former and a color developer, which react with each other under the influence of heat and thus lead to color development. Inexpensive color developers containing phenol groups (bisphenol A, bisphenol S, etc.) are widely used. These can be used to produce thermal labels that have an acceptable performance profile for certain applications.

Thermal labels that contain a phenol group-free color developer in the heat-sensitive color-forming layer are also known from the prior art. These were developed to improve the durability of the typeface, especially when the printed heat-sensitive recording material comes into contact with hydrophobic substances, such as substances or materials containing plasticizers or oils. In addition to the technical advantages, public discussions about the toxic potential of (bis)phenolic chemicals in particular have greatly stimulated interest in phenol group-free color developers.

Storage of thermally printed self-adhesive thermal labels or heat-sensitive recording materials with back-coatings over longer periods of time, particularly at high ambient temperatures and/or air humidity, can result in impairments to the application properties. In particular, heat-sensitive recording materials with such back-coatings can no longer achieve the specified values for the degree of blackness of the printout (e.g. of the barcode or the typeface) or the surface whiteness after storage.

However, a low degree of blackness of the printout generally leads to a reduction in the reading contrast and is further worsened by the drop in the background whiteness. Since the readability of the barcode, for example, is important, particularly in label applications, low contrast values have a detrimental effect on this important application property.

The cause of this phenomenon is said to be the adhesive layer on the back, from which substances migrate through the carrier substrate into the chemically reactive heat-sensitive recording layer over the course of storage and interact with it in a way that is harmful to the color complex. The greatest contribution to the migration problem is made by substances with a relatively low molecular weight (<10 kDa). The impairment of performance after storage can also occur when a heat-activated adhesive, i.e. one that is solid at room temperature, is used.

In particular, color developers with chemical structures that are more complex than structurally relatively simple (bis)phenols, which have a large number of reactive sites in the molecule, as is often the case with color developers that do not contain phenol groups, can be affected by the problem of undesirable interaction with substances that can be released from heat-sensitive recording materials that have been treated with a back preparation.

To ensure the cohesive strength within the adhesive layer of pressure-sensitive adhesives and the adhesion strength (adhesion) to the substrate, non-polymeric tacky resins (e.g. natural or carbon resins) and/or plasticizers, tackifiers and possibly other small-molecular additives such as crosslinkers, stabilizers, etc. are used in typical pressure-sensitive adhesive formulations in addition to a base polymer. If one takes into account that the base polymers contain residual monomers or oligomers from the synthesis process and can form further monomers due to the hydrolytic degradation promoted by high ambient humidity and temperatures, the migration potential of small-molecular substances inherent in an adhesive layer can easily be recognized.

In addition to the above-described possibilities of the presence of residual monomers in the latex, the presence of typical process-related substances such as surfactants, soaps, initiators during emulsion polymerization must be taken into account when evaluating the migration potential of the polymer components of the back-coat coatings.

The prior art offers different solutions to this problem for adhesive thermal labels: the application of an additional layer between the back of the carrier substrate and the adhesive layer (so-called back-coat), as in U.S. Pat. No. 4,370,370 A and EP 2 474 963 B1, or the incorporation of special substances, e.g. carboxylated polyvinyl alcohols, into the adhesive layer, as described in JPS 59 162 087A.

However, these solutions are economically disadvantageous because they require additional production steps and make the label material more complex overall, and are only able to minimize the migration problem of back coatings if they use more expensive, low-migration binders.

### DETAILED DESCRIPTION

The object of the present disclosure is to optimize the property profile of a thermally printed heat-sensitive recording material, which has an adhesive layer on the back, in particular to limit the loss of image stability as much as possible after storage of the heat-sensitive recording material, especially when the heat-sensitive recording material is stored for a longer period of time.

The image stability is characterized by the image durability after storage of the heat-sensitive recording material, whereby the image stability can also be characterized in particular by the print contrast.

Thus, the present disclosure aims to improve the minimum storage life of a heat-sensitive recording material, while at the same time maintaining the usual high requirements for such a heat-sensitive recording material, such as dynamic sensitivity, contrast, etc.

Surprisingly, it has now been found that the disadvantages of the prior art described above can be remedied by using a combination of at least one color developer with groups capable of forming hydrogen bonds, which are selected from the group consisting of —NHCO—, —CONH—, —NHCONH—, —CONHNHCO—, —NHCOCONH—, —SO₂NH— and —NHSO₂, with 5-(N-3-methylphenylsulfonylamido)-(N′,N″-bis-{3-methylphenyl)-isophthalic acid diamide (trade name PF425) as a stabilizer in the heat-sensitive layer of the heat-sensitive recording material.

In particular, the use of this combination consisting of the corresponding at least one color developer and stabilizer in the heat-sensitive layer of the heat-sensitive recording material leads to a limitation of the loss of image stability after storage under demanding environmental conditions of heat-sensitive recording materials provided with back preparations, so that the use of both components in the heat-sensitive layer leads to a synergistic effect.

The above-mentioned object is solved according to the first aspect by a heat-sensitive recording material comprising a carrier substrate, which has a first side and a second side facing away from the first side; a heat-sensitive color-forming layer, which is arranged on the first side of the carrier substrate, wherein the heat-sensitive color-forming layer comprises at least one color former, at least one color developer, and at least one stabilizer; and an adhesive layer, which is arranged on the second side of the carrier substrate, wherein the adhesive layer comprises at least one adhesive; wherein the weight ratio of stabilizer to color developer in the heat-sensitive color-forming layer is selected such that migration of components from the adhesive layer into the heat-sensitive color-forming layer according to the stability test defined in the description after a period of two weeks leads to a remaining image stability of the heat-sensitive color-forming layer of at least 35%.

According to the first aspect, the stabilizer comprises a compound of formula (I):

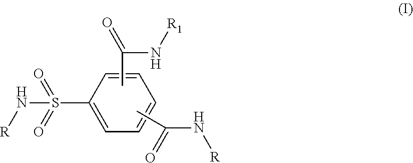

wherein R and R₁ are independently selected from the group comprising hydrogen, C₁-C₁₈-alkyl, C₁-C₈-alkoxy-C₁-C₈-alkyl, and (R₉)₂N—C₁-C₈-alkyl, wherein R₉ is selected from the group comprising C₁-C₈-alkyl, C₅-C₆-cycloalkyl; or a compound of formula (II)

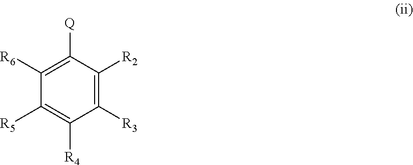

wherein R₂, R₃, R₄, R₅, and R₆ are independently selected from the group comprising hydrogen, C₁-C₈-Alkyl, —NH—C(═O)—R₇, and —C(═O)—NH—R₇, wherein R₇ is selected as C₁-C₈-Alkyl or —C(═O)OR₈, wherein R₈ is selected as C₁-C₈-alkyl or halogen, or wherein R₂ and R₃, or R₄ and R₅ or both, or wherein R₃ and R₄, or R₅ and R₆, or both, or wherein R₂ and R₃ and R₅ and R₆, together form a hydrocarbon group having three or four carbon atoms, and
wherein Q comprises a single bond or C₁-C₈-alkylene, which may be branched or unbranched, and wherein the C₁-C₈-alkylene comprises a main chain having one or more oxygen atoms between two carbon atoms, if the C₁-C₈-alkylene has more than two carbon atoms.

According to the first aspect, the at least one color developer comprises a compound of the formula (N-I):

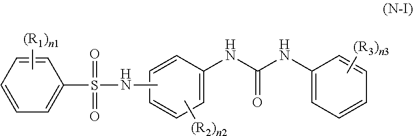

wherein R₁, R₂, and R₃ are independently selected from the group comprising hydrogen, halogen, nitro, C₁-C₆-alkyl, C₁-C₆-alkoxyl, C₂-C₆-alkenyl, C₁-C₆-fluoroalkyl, N(R₄)₂, NHCOR₅, optionally substituted phenyl, and optionally substituted benzyl, wherein R₄ is selected from the group comprising hydrogen, phenyl, benzyl, and C₁-C₆-alkyl, wherein R₅ is selected as C₁-C₆-alkyl, wherein n1 and n3 are independently selected as an integer from 1 to 5, and wherein n2 is an integer from 1 to 4;
and/or the at least one color developer comprises a compound of formula (I):

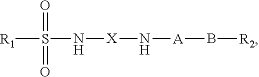

wherein R₁ is selected from the group comprising unsubstituted or substituted phenyl, naphthyl and C₁-C₂₀-alkyl, wherein X is selected from the group comprising —C(═NH)—, —C(═S)— and —C(═O)—, wherein A is selected from the group comprising unsubstituted or substituted phenylene, naphthylene, C₁-C₁₂-alkylene, and an unsubstituted or substituted heterocyclic group, wherein B is selected from the group comprising —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O—PO—(OR₂)₂, and wherein R₂ is selected from the group comprising unsubstituted or substituted aryl, benzyl and C₁-C₂₀-alkyl, with the proviso that when B is not a group of the formula —O—SO₂— then R₂ is unsubstituted or substituted phenyl, naphthyl or C₁-C₈-alkyl, and that when B is —O—, then R₂ is not alkyl.

The combination of the stabilizer and the color developer in the heat-sensitive color-forming layer advantageously leads to a limitation of the loss of image stability and in particular also of the relative print contrast, wherein the image stability and/or the relative print contrast of the heat-sensitive recording material stored according to the stability test (as defined below) is always greater than the value obtained using the same heat-sensitive recording material without the use of the stabilizer. This effect is particularly evident in the commercially available, critical average current range of 9.00 mJ/mm².

Without being bound to theory, it is assumed that the stabilizer, due to the color complex-stabilizing interactions resulting from its functional groups, such as hydrogen bonds, π-π interactions and/or ionic interactions, contributes to maintaining the color complex, in interaction with the color developer and color former, and the typeface under the influence of destabilizing influences such as water, chemicals and critical climatic conditions.

In particular, the at least one stabilizer comprises a compound of formula (I) which does not comprise a hydroxy-substituted phenyl substituent and can therefore also be referred to as a compound free of phenol groups.

In particular, the at least one color developer comprises a compound of formula (N-I) or (1) which does not comprise a hydroxy-substituted phenyl radical and can therefore also be referred to as a compound free of phenol groups.

The heat-sensitive recording material is well suited for applications in which the heat-sensitive recording material is provided with an adhesive layer on the back, which is printed using the thermal direct process and must guarantee a long storage life even under critical environmental conditions in relation to the specified image stability and print contrast values.

The present disclosure is not subject to any significant restrictions with regard to the choice of adhesive applied to the back. Adhesives that are sticky at room temperature as well as those that only become sticky after activation, for example by heat, are possible. Both permanent adhesives and removable adhesives can be used. The application technology of the adhesive to the back of the heat-sensitive recording material also does not restrict the scope of the disclosure in any way. Aqueous dispersions of the adhesive or adhesives dissolved or suspended in organic media, as well as adhesives applied in the molten state, so-called hot melt adhesives, can be used.

In summary, it can be stated that it has surprisingly been shown that it is possible to obtain heat-sensitive recording materials, in particular thermal labels, by using at least one color developer and the stabilizer according to the first aspect of the present disclosure, which are characterized by high image stability and good contrast values of the printed image (print contrast) during thermal printing after long-term storage under critical environmental conditions.

The heat-sensitive recording material according to the disclosure relates to the application-relevant case of a self-adhesive heat-sensitive recording material, i.e. a heat-sensitive recording material which has an adhesive layer on the side of the carrier substrate facing away from the heat-sensitive color-forming layer.

In the context of the present disclosure, the stability test defined below involves storing the heat-sensitive recording material for a period of two weeks between two glass plates at 60 °C, at a pressure of 1350 N/m², at a relative humidity of 50% and with exclusion of light.

As part of the stability test according to the present disclosure, the image stability of the heat-sensitive recording material is determined based on the optical density once before storing the heat-sensitive recording material and after the heat-sensitive recording material has been stored for two weeks. The two determined values of the optical density are related to each other, as is illustrated by the following formula A, with the scatter of the calculated % values being ≤±2 percentage points:

Image stability in %=(optical density after storage/optical density before storage)×100 (Formula A)

As part of the stability test according to the present disclosure, the optical density was measured with a SpectroEye densitometer from X-Rite, with the measurement uncertainty of the measured value being estimated at ≤2%.

The image stability of a heat-sensitive recording material according to the present disclosure tested in accordance with the stability test, preferably at an energization energy of 9.00 mJ/mm², is at least 35% after the storage period of two weeks.

To carry out the stability test, a DIN A4 heat-sensitive recording material with an adhesive layer on the side of the carrier substrate facing away from the heat-sensitive color-forming layer is divided lengthwise into at least two 6 cm wide strips.

One of these strips is printed and measured to determine the optical density before storage. The unprinted strip is placed on the printed strip (simulating a thermal roll) and then the stack is stored for two weeks (or, according to some examples, for four weeks) between two glass plates at 60 °C, at a pressure of 1350 N/m², at a relative humidity of 50% and with exclusion of light.

After storage and conditioning to room temperature, the optical density is determined, averaged and related to the optical density values determined at the beginning before storage in order to determine the image stability according to the above-mentioned formula A.

In addition to the image stability of the heat-sensitive recording material, the relative print contrast can also be taken into account as a further criterion for the image stability of the heat-sensitive recording material.

The relative print contrast (DK in %) is calculated based on the value of the optical density of a thermally printed area, i.e. an optical density of a print pattern (oDs) and the optical density of a non-printed area (oDw) according to the following formula B, whereby the scatter of the calculated % values is ≤±2 percentage points:

DK in %=(oDs−oDw/oDs)×100 (Formula B)

The relative print contrast of a heat-sensitive recording material tested according to the stability test, preferably at an energization energy of 9.00 mJ/mm², is at least 50% after a storage period of two weeks.

According to the first aspect, the stabilizer comprises a compound of formula (I):

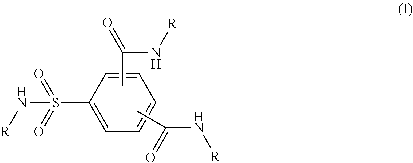

wherein R and R₁ are independently selected from the group comprising hydrogen, C₁-C₁₃-alkyl, C₁-C₈-alkoxy-C₁-C₈-alkyl, and (R₉)₂N—C₁-C₈-alkyl, wherein R₉ is selected from the group comprising C₁-C₈-alkyl, C₅-C₆-cycloalkyl; or a compound of formula (II)

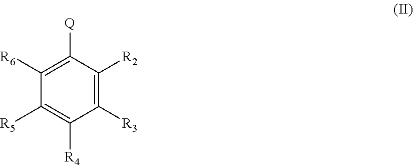

wherein R₂, R₃, R₄, R₅, and R₆ are independently selected from the group comprising hydrogen, C₁-C₈-alkyl, —NH—C(═O)—R₇, and —C(═O)—NH—R₇, wherein R₇ is selected as C₁-C₈-alkyl or —C(═O)OR₈, wherein R₈ is selected as C₁-C₈-alkyl or halogen, or wherein R₂ and R₃, or R₄ and R₅, or both, or wherein R₃ and R₄, or R₅ and R₆, or both, or wherein R₂ and R₃ and R₅ and R₆, together form a hydrocarbon group having three or four carbon atoms, and
wherein Q comprises a single bond or C₁-C₈-alkylene, which may be branched or unbranched, and wherein the C₁-C₈-alkylene comprises a main chain having one or more oxygen atoms between two carbon atoms, if the C₁-C₈ alkylene has more than two carbon atoms.

Preferably, the hydrocarbon group formed by R₂ and R₃ and R₅ and R₆ together with three or four carbon atoms comprises trimethylene, tetramethylene, propenylene, 2-butenylene or 1,3-butadienylene.

Preferably, R₃ is selected as a halogen, with R₃ more preferably selected as chlorine.

Preferably, Q is selected as —CH₂—, —CH₂—CH₂—, —CH₂—O—, —CH₂—CH₂—O—, —CH₂—CH₂—CH₂—, —CH₂—CH₂—CH₂—CH₂—, —C(Me)H—, —C(Et)H—, —C(n-Pr)H—, —C(i-Pr)H—, —C(n-Bu)H—, —C(i-Bu)H—, —C(sec-Bu)H—, —C(tert-Bu)H—, —C(Me)HCH₂—, —CMe₂CH₂—, wherein Q is more preferably selected as —CH₂—, —CH₂—CH₂—, —CH₂—CH₂—O— oder —C(Me)H—.

Preferably, the selection “C₁-C₁₈ alkyl” comprises methyl, ethyl, propyl, isopropyl, N-butyl, isobutyl, sec-butyl, tert-butyl, amyl, tert-amyl (1,1-dimethylpropyl), 1,1,3,3-tetramethylbutyl, N-hexyl, 2-methylpentyl, neopentyl, N-heptyl, 2-ethyl-hexyl or N-octyl, N-nonyl, N-decyl, N-undecyl, N-dodecyl, N-tridecyl, N-tetradecyl, N-pentadecyl, N-hexadecyl, N-heptadecyl, or N-octadecyl.

The selection “C1-C8 alkyl” preferably includes methyl, ethyl, propyl, isopropyl, N-butyl, isobutyl, sec-butyl, tert-butyl, amyl, tert-amyl (1,1-dimethylpropyl), 1,1,3,3-tetramethylbutyl, N-hexyl, 2-methylpentyl, neopentyl, N-heptyl, 2-Ethyl-hexyl or N-octyl, or tridecyl, more preferably methyl, ethyl, N-propyl, isopropyl, N-butyl, isobutyl, sec-butyl, tert-butyl, 2-ethyl-hexyl or tridecyl.

Preferably, the selection “C₁-C₈ alkoxy” includes methoxy, ethoxy, N-propoxy, isopropyloxy, N-butyloxy, N-pentyloxy, N-hexyloxy, N-heptyloxy, or N-octyloxy. More preferably, the selection “C₁-C₈-alkoxy” includes the selection “C₁-C₆-alkoxy”, even more preferably methoxy, ethoxy, N-propoxy, isopropoxy, N-butyloxy, or N-hexyloxy.

The selection “C₁-C₈-alkoxy-C₁-C₈-alkyl” preferably includes methoxymethyl, ethoxymethyl, N-propoxymethyl, isopropoxymethyl, N-butyloxymethyl, N-pentyloxymethyl, N-hexyloxymethyl, N-heptyloxymethyl, N-octyloxymethyl, methoxyethyl, ethoxyethyl, N-propoxyethyl, isopropoxyethyl, N-butyloxyethyl, N-pentyloxyethyl, N-hexyloxyethyl, N-heptyloxyethyl, N-octyloxyethyl, methoxymethyl, 1-methoxyethyl, 2-methoxyethyl, 3-methoxy-n-propyl, 1-methoxy-2-propyl, 4-methoxy-n-butyl, 5-methoxy-n-pentyl, 6-methoxy-n-hexyl, 7-methoxy-n-heptyl, 8-methoxy or N-octyl, more preferably 2-methoxyethyl.

Preferably, the selection “C₅-C₆-cycloalkyl” includes cyclopentyl or cyclohexyl, more preferably cyclohexyl.

Preferably, the selection “(R₉)₂N—C₁-C₈-alkyl” includes 2-(dimethylamino)methyl, 2-(dimethylamino)ethyl, 2-(diethylamino)ethyl, 2-(diisopropylamino)ethyl, 2-(n-propylamino)ethyl, 3-(dimethylamino)propyl, or 3-(cyclohexylamino)propyl.

Preferably, the selection “R₂ and R₃ together” comprises tetramethylene if R₂ and R₃, or R₄ and R₅ or both, or if R₃ and R₄, or R₅ and R₆ or both, or if (R₂ and R₃) and (R₅ and R₆) together form a hydrocarbon group with three or four carbon atoms, such as in particular trimethylene, tetramethylene, propenylene, 2-butenylene, or 1,3-butadienylene.

Preferably, the compound of formula (II) is phenyl, benzyl, 3-methylphenyl, 2,6-diethylphenyl, o-isopropylphenyl, p-acetamidophenyl, 1-phenylethyl, 2-phenylethyl, 2-phenoxyethyl, 1-tetralino, or 2-tetralino.

According to one example, the stabilizer comprises a compound of formula (Ia):

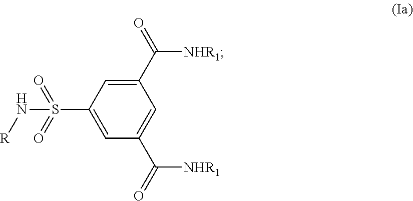

or the stabilizer comprises a compound of formula (Ib):

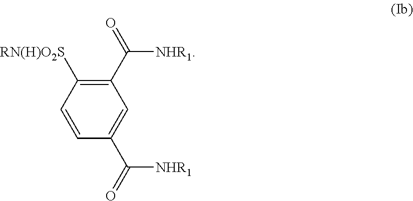

Preferably, the compound of formula (Ia) comprises at least one of the following compounds, 5-(N-benzyl-sulfonylamido)-(N′,N″-dibenzyl)-isophthalic acid diamide, 5-(N-3-methylphenyl-sulfonylamido)-(N′,N″-bis-(3-methylphenyl)-isophthalic acid diamide, 5-(N-2,6-diethylphenyl-sulfonylamido)-(N′,N″-bis-(2,6-diethyl phenyl)-isophthalic acid diamide, 5-(N-phenyl-sulfonylamido)-(N′,N″-bisphenyl)-isophthalic acid diamide, 5-(N-o-isopropyl-phenyl-sulfonylamido)-(N′,N″-bis-(o-isopropylphenyl)-isophthalic acid diamide, 5-(N-p-acetamido-phenyl-sulfonylamido)-(N′,N″-bis-(p-acetamido-phenyl)-isophthalic diamide, 5-(N-1-tetralino-sulfonylamido)-(N′,N″-bis-(1-tetralino)-isophthalic diamide, 5-(N-3-methyl phenyl-sulfonylamido)-(N′,N″-bis-(3-methylphenyl)-isophthalic acid diamide, 5-(N-1-phenyl ethyl-sulfonylamido)-(N′,N″-bis-(1-phenylethyl)-isophthalic acid diamide, 5-(N-2-phenylethyl-sulfonylamido)-(N′,N″-bis-(2-phenylethyl) isophthalic diamide, 5-(N-2,6-diethylphenyl-sulfonylamido)-(N′,N″-bis-(2,6-diethyl phenyl)-isophthalic acid diamide, 5-(N-n-butyl-sulfonylamido)-(N′,N″-di-n-butyl-isophthalic acid diamide, 5-(N-2-ethylhexyl-sulfonylamido)-(N′,N″-di-2-ethylhexyl-isophthalic acid diamide, 5-(N-benzyl-sulfonylamido)-(N′,N″-diphenyl)-isophthalic acid diamide, 5-(N-phenyl-sulfonylamido)-(N′,N″-dibenzyl)-isophthalic acid diamide, 5-(N-benzylsulfonylamido)-(N′,N″-bis-(3-methyl-phenyl)-isophthalic diamide, 5-(N-butyl-sulfonylamido)-(N′,N″-bis-(3-methyl-phenyl)-isophthalic acid diamide, 5-(N-1-phenyl-ethyl-sulfonylamido)-(N′,N″-bis-(3-methyl-phenyl)-isophthalic acid diamide, 5-(N-2-phenyl-ethyl-sulfonylamido)-(N′,N″-bis-(3-methyl-phenyl)-isophthalic diamide, 5-(N-2-methoxy-ethyl-sulfonylamido)-(N′,N″-bis-(3-methyl-phenyl)-isophthalic diamide, 5-(N-n-octyl-sulfonylamido)-(N′,N″-bis-(3-methyl-phenyl)-isophthalic diamide, 5-(N-benzyl-sulfonylamido)-(N′,N″-bis-(2,6-diethyl-phenyl)-isophthalic diamide, 5-(N-n-octyl-sulfonylamido)-(N′,N″-bis-(2,6-diethyl-phenyl)-isophthalic diamide, and 5-(N-2-phenoxy-ethyl-sulfonylamido)-(N′,N″-bis-(2,6-diethyl-phenyl)-isophthalic acid diamide.

In particular, the heat-sensitive recording material comprises a bisamide of the formula (Ic):

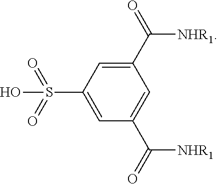

Preferably, the stabilizer is selected as a compound of the formula (Ia) and the heat-sensitive recording material comprises a bisamide of the formula (Ic), wherein more preferably the amount of the bisamide (Ic) is from 0.01 mol % to 10 mol % with respect to the compound of the formula (Ia).

According to one example, the stabilizer comprises 5-(N-3-methylphenylsulfonylamido)-(N′,N″-bis-{3-methylphenyl)-isophthalic acid diamide.

Here, the compound 5-(N-3-methylphenylsulfonylamido)-(N′,N″-bis-{3-methylphenyl)-isophthalic acid diamide comprises in particular three different polymorphic forms, comprising a α-polymorphic form with a melting point determined by DSC of 211.2 °C, a β-polymorphic form with a melting point determined by DSC of 192.2 °C and a γ-polymorphic form with a melting point determined by DSC of 215.6 °C.

According to the first aspect, the at least one color developer comprises a compound of formula (N-I):

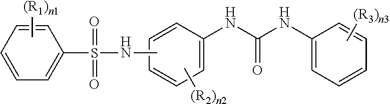

wherein R₁, R₂, and R₃ are independently selected from the group comprising hydrogen, halogen, nitro, C₁-C₆ alkyl, C₁-C₆ alkoxyl, C₂-C₆ alkenyl, C₁-C₆ fluoroalkyl, N(R₄)₂, NHCOR₅, optionally substituted phenyl, and optionally substituted benzyl, wherein R₄ is selected from the group comprising hydrogen, phenyl, benzyl, and C₁-C₆ alkyl, wherein R₅ is selected as C₁-C₆ alkyl, wherein n1 and n3 are independently selected as an integer from 1 to 5, and wherein n2 is an integer from 1 to 4.

Preferably, the compound of formula (N-I) is a compound of formula (IV) or a compound of formula (V), wherein R₁ and R₃ are as defined for the compound of formula (N-I):

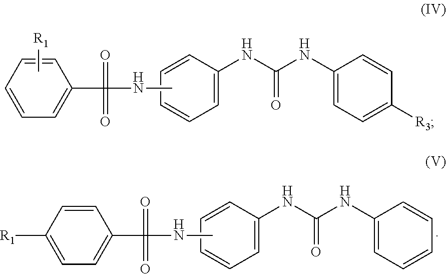

Preferably, the compound of formula (N-I) is a benzenesulfonamide compound.

Preferably, R₁, R₂ and/or R₃ is selected from hydrogen, halogen, more preferably fluorine, chlorine, bromine or iodine, nitro, a straight, branched or cyclic C₁-C₆-alkyl group, more preferably methyl, ethyl, propyl, isopropyl, butyl, isobutyl, sec-butyl, t-butyl, pentyl, isopentyl, neopentyl, hexyl, isohexyl, cyclopropyl, cyclobutyl, 2-methylcyclopropyl, cyclopropylmethyl, cyclopentyl, or cyclohexyl, a straight, branched or cyclic C₁-C₆-alkoxy group, more preferably methoxy, ethoxy, propoxy, isopropoxy, butoxy, isobutoxy, sec-butoxy, t-butoxy, pentyloxy, isopentyloxy, hexyloxy, cyclopropoxy, cyclobutoxy, 2-methylcyclopropoxy, cyclopropylmethoxy, cyclopentyloxy, or Cyclohexyloxy; a C₂-C₆-alkenyl group, more preferably a vinyl group, an allyl group, an isopropenyl group, a 1-propenyl group, a 2-propenyl group, a 1-butenyl group, a 2-butenyl group, a 3-butenyl group, a 1,3-butanedienyl group, or a 2-methyl-2-propenyl group, a C₁-C₆-fluoroalkyl group, more preferably a trifluoromethyl group, a perfluoroethyl group, a perfluoropropyl group, a perfluorobutyl group, a perfluorohexyl group, or a perfluorocyclohexyl group, an N(R₄)₂ group, wherein R₄ is more preferably selected as hydrogen, phenyl, benzyl or C₁-C₆-alkyl, an NHCOR₅ group, wherein R₅ is more preferably selected as C₁-C₆ alkyl, an optionally substituted phenyl group; and as an optionally substituted benzyl group.

Even more preferably, R₁, R₂ and/or R₃ is selected as hydrogen or a straight C₁-C₆ alkyl group, most preferably R₁ is hydrogen or methyl, and R₂ and R₃ are each hydrogen.

Even more preferably, the selections for the C₁-C₆ alkyl group selected according to R₄ or R₅ are the same as for the C₁-C₆ alkyl group selected according to R₁.

Even more preferably, the optional substituents of the optionally substituted groups are selected from hydroxy, halogen, most preferably fluorine, chlorine, bromine or iodine, C₁-C₆-alkyl, most preferably methyl, ethyl, N-propyl, isopropyl, N-butyl, sec-butyl, T-butyl, N-pentyl, isopentyl, neopentyl, T-pentyl, N-hexyl, isohexyl, 1-methyl-pentyl, or 2-methyl-pentyl, and C₁-C₆-alkoxy, most preferably methoxy, ethoxy, N-propoxy, isopropoxy, N-butoxy, sec-butoxy, or T-butoxy.

Preferably, the compound of formula (N-I) is selected from 4-methyl-N-(2-(3-phenylureido)phenyl)benzenesulfonamide and N-(2-(3-phenylureido)phenyl)benzenesulfonamide, more preferably N-(2-(3-phenylureido)phenyl)benzenesulfonamide.

According to one example, the at least one color developer comprises a compound of formula (N-I), wherein R₁, R₂, and R₃ are selected as hydrogen.

According to one example, the at least one color developer comprises N-(2-(3-phenylureido)phenyl)benzenesulfonamide, preferably the a-polymorph and/or the p-polymorph of N-(2-(3-phenylureido)phenyl)benzenesulfonamide.

In particular, the a-polymorph is characterized by an X-ray diffraction pattern with Bragg angles (2θ/CuKα) of 5.8, 9.3, 13.2, 15.7, 17.3, 18.3, 18.7, 19.5, 20.3, 21.1, 21.9, 22.8, 23.3, 23.6, 24.4, 24.9, 25.6, 26.7, 27.8, 28.1, 29.3, 29.6, 30.2, 31.6, 32.3, 32.8 and/or a melting point of 158 °C to 159 °C (onset) determined by DSC.

In particular, the β-polymorph is characterized by an X-ray diffraction pattern with Bragg angles (2θ/CuKα) of 10.0, 11.0, 12.3, 12.7, 13.8, 14.9, 15.6, 16.8, 17.7, 18.5, 20.1, 20.9, 21.6, 22.0, 22.8, 23.0, 23.6, 24.3, 25.5, 26.7, 27.8, 28.4, 29.0, 29.8, 30.5, 31.1, 31.3 and/or a melting point of 173 °C to 174 °C (on-set) determined by DSC.

The corresponding X-ray diffraction pattern was obtained by X-ray diffraction (XRD) measurement with a Bruker D2 Phaser, a Cu electrode, a voltage of 30 kV and a Lynxeye detector.

The corresponding melting point determined by DSC was measured by dynamic differential calorimetry with a Netzsch DSC 200 F3 Maia® device, an A1 crucible with a cold-welded perforated lid, a heating rate of 10 K/min and a temperature range of 25 °C to 200 °C under N₂ atmosphere.

The corresponding compound, N-(2-(3-phenylureido)phenyl)benzenesulfonamide, is also sold under the name NKK-1304.

Alternatively or in addition to the at least one color developer according to the formula (N-1), according to the first aspect, the at least one color developer comprises a compound of the formula (1):

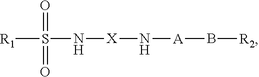

wherein R₁ is selected from the group comprising unsubstituted or substituted phenyl, naphthyl and C₁-C₂₀-alkyl, wherein X is selected from the group comprising —C(═NH)—, —C(═S)— and —C(═O)—, wherein A is selected from the group comprising unsubstituted or substituted phenylene, naphthylene, C₁-C₁₂-alkylene, and an unsubstituted or substituted heterocyclic group, wherein B is selected from the group comprising —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH— SO₂—, —O—CO—NH— SO₂—, —NH═CH—, —CO—NH—CO—, —S—, —CO—, —O—, —SO₂—NH—CO—, —O—CO—O— and —O— PO—(OR₂)₂, and wherein R₂ is selected from the group comprising unsubstituted or substituted aryl, benzyl and C₁-C₂₀ alkyl, with the proviso that when B is not a group of the formula —O—SO₂—, then R₂ is unsubstituted or substituted phenyl, naphthyl or C₁-C₈ alkyl, and that when B is —O—, then R₂ is not alkyl.

Preferably, R₁ is selected as phenyl or naphthyl, which may be unsubstituted or substituted by, for example, C₁-C₈ alkyl, C₁-C₈ alkoxy or halogen.

More preferably, the substituents are selected as C₁-C₄ alkyl, most preferably methyl or ethyl, C₁-C₄ alkoxy, more preferably methoxy or ethoxy, or halogen, more preferably chlorine.

More preferably, R₁ is selected as unsubstituted naphthyl.

More preferably, R₁ is selected as substituted phenyl, most preferably the substituents being selected as one of the abovementioned alkyl substituents.

Preferably, R₁ is selected as unsubstituted or substituted C₁-C₂₀-alkyl, more preferably C₁-C₈-alkoxy or halogen, even more preferably C₁-C₄-alkoxy, most preferably methoxy or ethoxy, or halogen, most preferably chlorine.

More preferably, R₁ is selected as unsubstituted C₁-C₂₀-alkyl.

More preferably, R₁ is unsubstituted phenyl or phenyl substituted by C₁-C₈-alkyl, C₁-C₈-alkoxy or halogen, with substituted phenyl being even more preferred. Most preferred is phenyl substituted by C₁-C₄-alkyl, even more preferably methyl.

Preferably, X is a group of the formula —C(═S)— or —C(═O)—, more preferably a group of the formula —C(═O)—.

Preferably, A is an unsubstituted phenylene or an unsubstituted naphthylene group, or a phenylene or a naphthylene group, which is more preferably substituted by C₁-C₈-alkyl, halogen-substituted C₁-C₈-alkyl, C₁-C₈-alkoxy-substituted C₁-C₈-alkyl, C₁-C₈-alkoxy, halogen-substituted C₁-C₈-alkoxy, C₁-C₈-alkylsulphonyl, halogen, phenyl, phenoxy or phenoxycarbonyl.

Even more preferred are alkyl and alkoxy substituents which comprise 1 to 4 carbon atoms, with C₁-C₈-alkyl, halogen-substituted C₁-C₈-alkyl, C₁-C₈-alkylsulphonyl or halogen being most preferred.

More preferably, A is an unsubstituted naphthylene group.

A is preferably a heterocyclic group, which more preferably comprises unsubstituted pyrimidylene or pyrimidylene, which is substituted by C₁-C₈ alkyl, even more preferably C₁-C₄ alkyl.

A is preferably a C₁-C₁₂-alkylene group, more preferably C₁-C₈-alkylene, even more preferably C₁-C₄-alkylene.

More preferably, A is unsubstituted phenylene or phenylene which is substituted by C₁-C₈-alkyl, halogen-substituted C₁-C₈-alkyl, C₁-C₈-alkoxy-substituted C₁-C₈-alkyl, C₁-C₈-alkoxy, halogen-substituted C₁-C₈-alkoxy, C₁-C₈-alkylsulphonyl, halogen, phenyl, phenoxy or phenoxycarbonyl, even more preferably C₁-C₈-alkyl, halogen-substituted C₁-C₈-alkyl, C₁-C₈-alkylsulphonyl or halogen.

Most preferably, A is unsubstituted phenylene or phenylene, which is substituted by C₁-C₄-alkyl or halogen, even more preferably unsubstituted phenylene.

Preferably, B is selected as —O—SO₂—, —SO₂—O—, —SO₂— NH—, —S—SO₂—, —O—, —O—CO— and —O—CO—NH—, more preferably as —O—SO₂—, —SO₂—O— and —SO₂—NH—, and most preferably as —O—SO₂— and —O—.

Preferably, R₂ is aryl, more preferably phenyl or naphthyl, which is unsubstituted or substituted, even more preferably by C₁-C₈-alkyl, halogen-substituted C₁-C₈-alkyl, C₁-C₈-alkoxy-substituted C₁-C₈-alkyl, C₁-C₈-alkoxy, halogen-substituted C₁-C₈-alkoxy or halogen, most preferably alkyl and alkoxy substituents comprising 1 to 4 carbon atoms, wherein C₁-C₄-Alkyl and halogen are the even more preferred substituents.

Preferably, R₂ is naphthyl, which is even more preferably unsubstituted.

Preferably, R₂ is benzyl, which is substituted by the substituents already mentioned for the selection of R₂ as phenyl or naphthyl, with unsubstituted benzyl being even more preferred.

Preferably, R₂ is C₁-C₂₀ alkyl, more preferably C₁-C₈ alkyl, even more preferably C₁-C₆ alkyl, which is unsubstituted or substituted by, for example, C₁-C₈ alkoxy, halogen, phenyl or naphthyl, with most preferred unsubstituted alkyl groups, even more preferably C₁-C₄ alkyl.

More preferably, R2 is C₁-C₆-alkyl, halogen-substituted C₁-C₆-alkyl, phenyl-substituted C₁-C₆-alkyl, naphthyl-substituted C₁-C₆-alkyl, unsubstituted phenyl, or phenyl which is substituted by C₁-C₈-alkyl, halogen-substituted C₁-C₈-alkyl, C₁-C₈-alkoxy-substituted C₁-C₈-alkyl, C₁—C-alkoxy, halogen-substituted C₁-C₈-alkoxy or halogen, naphthyl and benzyl which is substituted by C₁-C₄-alkyl or halogen.

Even more preferably, R₂ is C₁-C₄ alkyl, halogen-substituted C₁-C₄ alkyl, phenyl which is unsubstituted or substituted by C₁-C₄ alkyl or halogen, naphthyl and benzyl, which is unsubstituted or substituted by C₁-C₄ alkyl or halogen, most preferably phenyl which is unsubstituted or substituted by C₁-C₄ alkyl or halogen.

Preferably, R1 is phenyl which is substituted by C₁-C₄-alkyl, more preferably methyl, X is —C(═O)—, A is phenylene, which is unsubstituted or substituted by C₁-C₈-alkyl or halogen, with unsubstituted phenylene being more preferred, such as 1,3-phenylene, B is a group of the formula —O—SO₂— or —O—, and R₂ is phenyl, naphthyl or benzyl which is unsubstituted or substituted by C₁-C₄-alkyl or halogen, with phenyl which is substituted by C₁-C₄-alkyl being more preferred.

According to one example, the at least one color developer of formula (I) comprises 4-methyl-N-(((3-(((4-methylphenyl)sulfonyl)oxy)phenyl)amino)carbonyl)benzenesulfonamide, preferably the α-polymorph and/or the β-polymorph of 4-methyl-N-(((3-(((4-methylphenyl)sulfonyl)oxy)phenyl)amino)carbonyl)benzenesulfonamide.

In particular, the α polymorph is characterized by an X-ray diffraction pattern with Bragg angles (2θ/CuKα) of 8.5, 9.5, 11.8, 12.1, 12.2, 13.7, 14.1, 16.6, 17.1, 18.3, 18.6, 19.1, 19.3, 20.1, 20.4, 20.9, 21.3, 23.1, 24.2, 24.6, 25.0, 27.9, 28.6 and/or a melting point determined by DSC of 161 °C to 162 °C.

In particular, the β polymorph is characterized by an X-ray diffraction pattern with Bragg angles (2θ/CuKα) of 10.3, 11.0, 12.9, 13.2, 15.4, 17.1, 18.0, 18.2, 19.4, 20.0, 20.7, 21.2, 23.0, 24.9, 25.3, 26.5, 26.8, 27.5, 30.7, 32.7 and/or a melting point determined by DSC of 166 °C to 167 °C.

The corresponding X-ray diffraction pattern was obtained by X-ray diffraction (XRD) measurement with a Bruker D2 Phaser, a Cu electrode, a voltage of 30 kV and a Lynxeye detector.

The corresponding melting point determined by DSC was measured by dynamic differential calorimetry with a Netzsch DSC 200 F3 Maia® device, an AI crucible with a cold-welded, perforated lid, a heating rate of 10 K/min and a temperature range of 25 °C to 200 °C under N₂ atmosphere.

According to one example, the weight ratio of stabilizer to color developer in the heat-sensitive color-forming layer is from 1 to 11 to 1 to 1, preferably from 1 to 8 to 1 to 4, more preferably from 1 to 7 to 1 to 5, and most preferably 1 to 6.

With the corresponding weight ratios of stabilizer to color developer in the heat-sensitive color-forming layer, a particularly high image stability of the heat-sensitive marking material and in particular also a high remaining print contrast are shown in the stability test defined in the description after a period of two weeks.

In particular, the stabilizer is selected as 5-(N-3-methylphenylsulfonylamido)-(N′,N″-bis-{3-methylphenyl)isophthalic acid diamide (trade name PF425) and the at least one color developer is selected as N-(2-(3-phenylureido)phenyl)benzenesulfonamide (trade name NKK-1304), and/or 4-methyl-N-(((3-(((4-methylphenyl)sulfonyl)oxy)phenyl)amino)carbonyl)benzenesulfonamide (trade name PF-201), wherein the weight ratio of stabilizer to color developer in the heat-sensitive color-forming layer is from 1 to 11 to 1 to 1, preferably from 1 to 8 to 1 to 4, more preferably from 1 to 7 to 1 to 5, and most preferably 1 to 6.

According to one example, the stabilizer has a weight proportion of 1 wt. % to 10 wt. % based on the total solids content of the heat-sensitive color-forming layer, the weight proportion preferably being from 2 wt. % to 8 wt. %, more preferably from 3 wt. % to 6 wt. %, and most preferably 4 wt. %.

With the corresponding weight proportion of the stabilizer in the heat-sensitive color-forming layer, a particularly high remaining image stability of the heat-sensitive color-forming layer, and in particular also a high remaining print contrast, is shown after a period of two weeks in the stability test defined in the description.

In particular, the stabilizer is selected as 5-(N-3-methylphenylsulfonylamido)-(N′,N″-bis-{3-methylphenyl)-isophthalic acid diamide (trade name PF425) and the stabilizer has a weight proportion of 1 wt. % to 10 wt. % based on the total solids content of the heat-sensitive color-forming layer, wherein the weight proportion is preferably from 2 wt. % to 8 wt. %, more preferably from 3 wt. % to 6 wt. %, and most preferably 4 wt. %.

According to one example, the at least one color developer has a weight proportion of 6 wt. % to 35 wt. % based on the total solids content of the heat-sensitive color-forming layer, wherein the weight proportion is preferably from 10 wt. % to 30 wt. %, more preferably from 20 wt. % to 30 wt. %, and most preferably 24 wt. %.

In the corresponding weight proportion of the at least one color developer in the heat-sensitive color-forming layer a particularly high remaining image stability of the heat-sensitive color-forming layer was shown after a period of two weeks in the stability test defined in the description, and in particular also a high remaining print contrast.

In particular, the at least one color developer is selected as N-(2-(3-phenylureido)phenyl)benzenesulfonamide (trade name NKK-1304), and/or 4-methyl-N-(((3-(((4-methylphenyl)sulfonyl)oxy)phenyl)amino)carbonyl)benzenesulfonamide (trade name PF-201), wherein the at least one color developer has a weight proportion of 6 wt. % to 35 wt. % based on the total solids content of the heat-sensitive color-forming layer, wherein the weight proportion is preferably from 10 wt. % to 30 wt. %, more preferably from 20 wt. % to 30 wt. %, and most preferably 24 wt. %.

According to one example, the image stability of the heat-sensitive color-forming layer remaining after a period of two weeks is at least 40%, preferably at least 45%, more preferably at least 50%, even more preferably at least 55%, even more preferably at least 60%, even more preferably at least 65%, even more preferably at least 70%, even more preferably at least 75% and most preferably at least 80%.

A correspondingly high image stability of the heat-sensitive color-forming layer remaining after a period of two weeks ensures high image stability of the heat-sensitive recording material.

According to one example, the adhesive comprises a pressure-sensitive adhesive and/or a heat-activatable adhesive, the adhesive preferably being a permanently adhesive hot-melt adhesive based on styrene-isoprene and PVC copolymers, and/or the adhesive preferably being a removable adhesive based on acrylate, and/or the adhesive preferably being a permanently adhesive hot-melt adhesive based on synthetic rubber.

This achieves the technical advantage that a large number of different adhesive types can be used in the adhesive layer of the heat-sensitive recording material according to the disclosure, and yet the image stability remaining after a period of two weeks according to the stability test is at least 35%.

For example, a permanently adhesive hot-melt adhesive based on styrene-isoprene and PVC copolymers is the S2200 adhesive from Avery Dennison.

For example, a removable adhesive based on acrylate is the adhesive R5000N from Avery Dennison.

For example, a permanently adhesive hot melt adhesive based on synthetic rubber is the adhesive Technomelt PS 8746 from Henkel.

According to one example, the adhesive comprises a permanently adhesive hot melt adhesive based on styrene-isoprene and PVC copolymers, wherein the weight ratio of stabilizer to color developer in the heat-sensitive color-forming layer is from 1 to 11 to 1 to 1, preferably from 1 to 8 to 1 to 4, more preferably from 1 to 7 to 1 to 5, and most preferably 1 to 6.

According to one example, the color developer comprises the β-polymorphic form of N-{2-[(phenylcarbamoyl)amino]phenyl}benzenesulfonamide, and/or comprises the α-polymorphic form of 4-methyl-N-(((3-(((4-methylphenyl)sulfonyl)oxy)phenyl)amino)carbonyl)benzenesulfonamide.

This achieves the technical advantage that when using a permanently adhesive hot melt adhesive based on styrene-isoprene and PVC copolymers, when using the β-polymorphic form of N-{2-[(phenylcarbamoyl)amino]phenyl}benzenesulfonamide (NKK-1304), and/or when using the α-polymorphic form of 4-methyl-N-(((3-(((4-methylphenyl)sulfonyl)oxy)phenyl)amino)carbonyl)benzenesulfonamide (PF-201), particularly advantageous results are achieved when determining the image stability according to the stability test.

According to one example, the image stability of the heat-sensitive color-forming layer remaining after a period of two weeks is at least 40%, preferably at least 45%, more preferably at least 50%, even more preferably at least 55%, even more preferably at least 60%, even more preferably at least 65%, even more preferably at least 70%, even more preferably at least 75% and most preferably at least 80%.

According to one example, the adhesive comprises a removable acrylate-based adhesive, wherein the weight ratio of stabilizer to color developer in the heat-sensitive color-forming layer is from 1 to 11 to 1 to 1, preferably from 1 to 8 to 1 to 4, more preferably from 1 to 7 to 1 to 5, and most preferably 1 to 6.

According to one example, the color developer comprises the α-polymorphic form of N-{2-[(phenylcarbamoyl)amino]phenyl}benzenesulfonamide.

This achieves the technical advantage that when using a removable acrylate-based adhesive, particularly advantageous results are achieved in determining image stability according to the stability test when using the α-polymorphic form of N-{2-[(phenylcarbamoyl)amino]phenyl}benzenesulfonamide (NKK-1304).

According to one example, the image stability of the heat-sensitive color-forming layer remaining after a period of two weeks is at least 40%, preferably at least 45%, more preferably at least 50%, even more preferably at least 55%, even more preferably at least 60%, even more preferably at least 65%, even more preferably at least 70%, even more preferably at least 75% and most preferably at least 80%.

According to one example, the adhesive comprises a permanently adhesive hot melt adhesive based on synthetic rubber, wherein the weight ratio of stabilizer to color developer in the heat-sensitive color-forming layer is from 1 to 11 to 1 to 1, preferably from 1 to 8 to 1 to 4, more preferably from 1 to 7 to 1 to 5, and most preferably 1 to 6.

According to one example, the color developer comprises the α-polymorphic form of N-{2-[(phenylcarbamoyl)amino]phenyl}benzenesulfonamide, and/or the color developer comprises the α-polymorphic form of 4-methyl-N-(((3-(((4-methylphenyl)sulfonyl)oxy)phenyl)amino)carbonyl)benzenesulfonamide

This achieves the technical advantage that when using a permanently adhesive hot melt adhesive based on synthetic rubber, when using the α-polymorphic form of N-{2-[(phenylcarbamoyl)amino]phenyl}benzenesulfonamide (NKK-1304) and/or when using the a-polymorphic form of 4-methyl-N-(((3-(((4-methylphenyl)sulfonyl)oxy)phenyl)amino)carbonyl)benzenesulfonamide (PF201), particularly advantageous results are achieved when determining image stability according to the stability test.

According to one example, the image stability of the heat-sensitive color-forming layer remaining after a period of two weeks is at least 40%, preferably at least 45%, more preferably at least 50%, even more preferably at least 55%, even more preferably at least 60%, even more preferably at least 65%, even more preferably at least 70%, even more preferably at least 75% and most preferably at least 80%.

According to one example, the image stability is determined by thermally printing the heat-sensitive recording material with a print pattern using a printer at an energy level of 9.00 mJ/mm² and a printing speed of about 100 mm/s, then measuring the optical density of the print pattern with a densitometer before storing the heat-sensitive recording material and measuring the optical density of the print pattern with the densitometer after a storage period of two weeks of the heat-sensitive recording material, wherein the image stability corresponds in particular to the quotient of the optical density of the print pattern after the storage period and the optical density of the print pattern before storage in %.

In particular, during the storage period of two weeks, a temperature of 60 °C and a humidity of 50% is maintained.

This achieves the technical advantage that a uniform stability test can be provided according to the present disclosure.

According to one example, the weight ratio of stabilizer to color developer in the heat-sensitive color-forming layer is selected such that the image stability of the heat-sensitive color-forming layer remaining after a period of two weeks is at least 35%, and that the print contrast of the heat-sensitive color-forming layer remaining after a period of two weeks is at least 50%, preferably at least 60%, and more preferably at least 70%, and most preferably at least 80%.

This achieves the technical advantage that taking the print contrast into account in addition to taking the image stability into account a particularly effective characterization of the quality of the heat-sensitive recording material is enabled.

According to one example, the print contrast remaining after two weeks is determined using the following formula, DK in %=(oDs−oDw/oDs)×100, wherein the parameter oDs corresponds to the optical density of the print pattern after a period of two weeks, and wherein the parameter oDw corresponds to the optical density of a non-printed area of the heat-sensitive recording material after a period of two weeks.

This achieves the technical advantage that an effective determination of the print contrast is possible.

According to one example, the at least one color former is a dye of the triphenylmethane type, the fluoran type, the azaphthalide type and/or the fluorene type, preferably a fluoran type dye.

The use of the particularly preferred fluoran type dye as at least one color former enables the provision of a heat-sensitive recording material with an advantageous price-performance ratio due to its availability and balanced application-related properties.

According to one example, a fluoran-type dye is selected from the group comprising 3-diethylamino-6-methyl-7-anilinofluoran, 3-(N-ethyl-N-4-toludinamino)-6-methyl-7-anilinofluoran, 3-(N-ethyl-N-isoamylamino)-6-methyl-7-anilinofluoran, 3-diethylamino-6-methyl-7-(2,4-dimethylanilino)fluoran, 3-pyrrolidino-6-methyl-7-anilinofluoran, 3-(cyclohexyl-N-methylamino)-6-methyl-7-anilinofluoran, 3-diethylamino-7-(3-trifluoromethylanilino)fluoran, 3-N-n-dibutylamino-6-methyl-7-anilinofluoran, 3-diethylamino-6-methyl-7-(3-methylanilino)fluoran, 3-N-n-dibutylamino-7-(2-chloroanilino)fluoran, 3-(N-ethyl-N-tetrahydrofurfurylamino)-6-methyl-7-anilinofluoran, 3-(N-methyl-N-propylamino)-6-methyl-7-anilinofluoran, 3-(N-ethyl-N-ethoxypropylamino)-6-methyl-7-anilinofluoran, 3-(N-ethyl-N-isobutylamino)-6-methyl-7-anilinofluoran, 3-dipentylamino-6-methyl-7-anilinofluoran and mixtures thereof.

According to one example, the at least one color former has a weight proportion of 3 wt. % to 30 wt. % based on the total solids content of the heat-sensitive color-forming layer, wherein the weight proportion is preferably from 5 wt. % to 20 wt. % and particularly preferably from 8 wt. % to 15 wt. %.

According to one example, the carrier substrate comprises paper, synthetic paper and/or a plastic film.

The carrier substrate is not limited here. The carrier material preferably has a basis weight of 30 g/m² to 100 g/m², in particular of 40 g/m² to 80 g/m².

In particular, the carrier substrate comprises a paper substrate made of hardwood and/or softwood pulp.

According to one example, the heat-sensitive recording material has at least one intermediate layer, which is arranged between the carrier substrate and the heat-sensitive color-forming layer, wherein the intermediate layer preferably comprises at least one pigment, and more preferably organic hollow sphere pigments and/or calcinated kaolins.

The organic hollow sphere pigments preferably comprise a styrene-acrylate copolymer. The organic hollow sphere pigments preferably have a glass transition temperature of 40 °C to 80 °C and/or an average particle size of 0.1 μm to 2.5 μm. In particular, the average particle size comprises the average particle size (D50).

The intermediate layer functions as a heat barrier between the carrier substrate and the heat-sensitive color-forming layer, and also makes it possible to improve the surface smoothness of the carrier substrate for the heat-sensitive color-forming layer.

According to one example, the heat-sensitive recording material has at least one protective layer and/or pressure support layer, which is arranged on the heat-sensitive color-forming layer on a side facing away from the adhesive layer, wherein the protective layer preferably comprises a binder and at least one pigment, and more preferably a binder and an inorganic pigment.

The protective layer and/or print support layer arranged on the outside of the heat-sensitive color-forming layer ensures effective protection or advantageous printability of the heat-sensitive color-forming layer.

According to one example, the binder is selected from the group comprising water-soluble starches, starch derivatives, starch-based biolatices of the EcoSphere type, methylcellulose, hydroxyethylcellulose, carboxymethylcellulose, partially or fully saponified polyvinyl alcohols, chemically modified polyvinyl alcohols, such as acetoacetyl-, diacetone-, carboxy-, silanol-modified polyvinyl alcohols, ethylene-vinyl alcohol copolymer (EVOH) or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates, acrylonitrile-butadiene copolymers and mixtures thereof, in particular (meth)acrylamide-acrylic acid ester based copolymers of the Bariastar® type can be used, which are preferably in the form of core-shell structures.

According to one example, the binder has a weight proportion of 30% by weight to 90% by weight based on the total solids content of the protective layer, the weight proportion preferably being from 40% by weight to 80% by weight.

According to one example, the binder is designed as a crosslinked binder, the crosslinked binder preferably being designed as a self-crosslinking binder, or the protective layer comprising a crosslinker which is designed to react with the binder to obtain the crosslinked binder.

To achieve specific application-related performance characteristics of a heat-sensitive recording material, the binder is preferably present in crosslinked form in the protective layer, the optimum degree of crosslinking of the binder being established during a drying step of the coating process, in particular in the presence of a crosslinker.

According to one example, the self-crosslinking binder comprises modified polyvinyl alcohols and/or modified acrylates.

Self-crosslinking binders, such as specially modified polyvinyl alcohols and/or modified acrylates, enable crosslinking without the addition of a crosslinker due to the reactive groups which are already part of the polymer of the self-crosslinking binder.

According to one example, the crosslinker is selected from the group comprising polyhydric aldehydes, preferably glyoxal, dialdehyde starch, and/or glutaraldehyde, in particular alone or in admixture with boron salts, salts or esters of glyoxylic acid, ammonium zirconium carbonate, polyamidoamine epichlorohydrin resins, adipic acid dihydrazide, boric acid or salts thereof, polyamines, epoxy resins, formaldehyde oligomers, cyclic ureas, methylol urea, and melamine formaldehyde oligomers and mixtures thereof, wherein the crosslinker is further preferably selected from the group comprising ammonium zirconium carbonate and polyamidoamine epichlorohydrin resins.

According to one example, the crosslinker has a weight proportion of 0.01 wt. % to 25.0 wt. % based on the total solids content of the protective layer, the weight proportion preferably being from 0.05 wt. % to 15 wt. %.

According to one example, the pigment comprises an inorganic pigment selected from the group comprising calcium carbonates, preferably synthetic, natural or precipitated calcium carbonates, aluminum oxides, aluminum hydroxides, silicas, precipitated and pyrogenic silicas, diatomaceous earths, magnesium carbonates, talc, kaolin, titanium oxide, bentonite and mixtures thereof, or wherein the pigment comprises an organic pigment selected from the group comprising hollow pigments with a styrene/acrylate copolymer wall, urea/formaldehyde condensation polymers, and mixtures thereof.

According to one example, the pigment has a weight proportion of 5% to 50% by weight based on the total solids content of the protective layer, the weight proportion preferably being from 10% to 45% by weight.

According to one example, the protective layer has at least one lubricant, the lubricant preferably being selected from the group comprising fatty acid metal salts, preferably zinc stearate or calcium stearate, behenate salts or synthetic waxes, preferably in the form of fatty acid amides, more preferably stearic acid amide and behenic acid amide, fatty acid alkanolamides, preferably stearic acid methylolamide, paraffin waxes of various melting points, ester waxes of different molecular weights, polyethylene waxes, polypropylene waxes of different hardnesses, natural waxes, preferably carnauba wax or montan wax, and mixtures thereof.

According to one example, the lubricant has a weight proportion of 1 wt. % to 30 wt. % based on the total solids content of the protective layer, wherein the weight proportion is preferably from 2 wt. % to 20 wt. %.

According to one example, the protective layer has at least one brightener, the brightener preferably being selected as a stilbene.

The brightener can advantageously adjust the surface whiteness of the heat-sensitive color-forming layer.

According to one example, the protective layer has a basis weight of 0.3 g/m² to 5.0 g/m², preferably 1.0 g/m² to 3.0 g/m².

According to one example, the protective layer has a thickness of 0.3 μm to 6.0 μm, preferably 0.5 μm to 2.0 μm.

According to one example, the protective layer has a Bekk smoothness measured according to the ISO 5267:1995-03 standard of 100 sec to 3000 sec, preferably 500 sec to 2000 sec.

A corresponding advantageous Bekk smoothness can be achieved by a smoothing process.

According to one example, the protective layer has a surface roughness measured according to the ISO 8791-4:2008-05 standard of 0.5 m to 2.50 m, preferably 1.00 m and 2.00 m.

In addition to the at least one color former, the at least one color developer and the at least one stabilizer, the heat-sensitive color-forming layer can also have at least one sensitizer according to one example, which has the advantage that the control of the thermal pressure sensitivity is easier to implement.

In general, crystalline substances whose melting point is between about 90 °C and about 150 °C and which, in the molten state, dissolve the color-forming components comprising the at least one color former and the at least one color developer without disturbing the formation of the color complex are advantageously considered as sensitizing agents. Sensitizer can be present either alone or as mixtures.

The at least one sensitizer is preferably selected from the group comprising a fatty acid amide, in particular stearic acid amide, beheneamide or palmitamide, an ethylene-bis-fatty acid amide, in particular N,N′-ethylene-bis-stearic acid amide or N,N′-ethylene-bis-oleic acid amide, a fatty acid alkanolamide, in particular N-(hydroxymethyl)stearic acid amide, N-hydroxymethylpalmitamide or hydroxyethylstearic acid amide, a wax, in particular polyethylene wax or montan wax, a carboxylic acid ester, in particular dimethyl terephthalate, dibenzyl terephthalate, benzyl 4-benzyloxybenzoate, di-(4-methylbenzyl)oxalate, di-(4-chlorobenzyl)oxalate or di-(4-benzyl)oxalate, an aromatic ether, in particular 1,2-diphenoxyethane, 1,2-di(3-methylphenoxy)ethane, 2-benzyloxynaphthalene or 1,4-diethoxynaphthalene, an aromatic sulfone, in particular diphenylsulfone, an aromatic sulfonamide, in particular benzenesulfonanilide or N-benzyl-4-toluenesulfonamide, aromatic hydrocarbons, in particular 4-benzylbiphenyl and mixtures thereof.

According to one example, the sensitizing agent has a weight proportion of 5 wt. % to 40 wt. % based on the total solids content of the heat-sensitive color-forming layer, the weight proportion preferably being from 10 wt. % to 25 wt.

In addition to the at least one color former, in addition to the at least one color developer, in addition to the at least one stabilizer and in addition to the optionally present sensitizing agent, the heat-sensitive color-forming layer can also have at least one further stabilizer according to one example.

The additional stabilizing agent serves as an anti-aging agent for the color complex in the heat-sensitive color-forming layer.

The additional stabilizing agent is preferably selected from the group comprising sterically hindered phenols, more preferably 1,1,3-tris-(2-methyl-4-hydroxy-5-cyclohexyl-phenyl)butane, 1,1,3-tris-(2-methyl-4-hydroxy-5-tert-butylphenyl)butane, and/or 1,1-bis-(2-methyl-4-hydroxy-5-tert-butyl-phenyl)butane, urea-urethane compounds, ethers derived from 4,4′-dihydroxydiphenylsulfone, more preferably 4-benzyloxy-4′-(2-methylglycidyloxy)-diphenylsulfone, oligomeric ethers and mixtures thereof.

The additional stabilizing agent preferably has a weight proportion of 0.2 wt. % to 1.0 wt. % based on the total proportion of the color developer in the heat-sensitive color-forming layer.

According to one example, the heat-sensitive color-forming layer has at least one further binder, which is preferably selected from the group comprising water-soluble starches, starch derivatives, starch-based biolatices of the EcoSphere® type, methylcelluloses, hydroxyethylcelluloses, carboxymethylcellulose, partially or fully saponified polyvinyl alcohols, chemically modified polyvinyl alcohols, ethylene-vinyl alcohol copolymer (EVOH) or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinylacetates, acrylonitrile-butadiene copolymers, and mixtures thereof, whereby in particular (meth)acrylamide-acrylic acid ester-based copolymers of the Bariastar® type are used, which are preferably in the form of core-shell structures.

To achieve specific application-related performance characteristics of heat-sensitive recording materials, preferably of self-adhesive heat-sensitive recording materials, in particular of self-adhesive labels, the binder is preferably present in cross-linked form in the heat-sensitive layer, whereby the optimum degree of cross-linking of the binder is established in the drying step of the coating process in the presence of a cross-linking agent.

The binder is preferably designed as a cross-linked additional binder, wherein the cross-linked additional binder is preferably designed as a self-cross-linking additional binder, or wherein the heat-sensitive color-forming layer comprises a further cross-linker which is designed to react with the additional binder in order to obtain the cross-linked additional binder.

The self-cross-linking additional binder further preferably comprises modified polyvinyl alcohols and/or modified acrylates.

The further cross-linker is further preferably selected from the group comprising polyvalent aldehydes, preferably glyoxal, dialdehyde starch, and/or glutaraldehyde, in particular alone or in a mixture with boron salts, salts or esters of glyoxylic acid, ammonium zirconium carbonate, polyamidoamine epichlorohydrin resins, adipic acid dihydrazide, boric acid or salts thereof, and mixtures thereof.

More preferably, the further crosslinker has a weight proportion of 2.5 wt. % to 20 wt. % based on the total proportion of the crosslinkable further binder in the heat-sensitive color-forming layer, the weight proportion preferably being from 5 wt. % to 15 wt. %.

According to one example, the carrier substrate, the heat-sensitive color-forming layer, and/or the adhesive layer are formed in one layer or in multiple layers.

According to one example, the heat-sensitive color-forming layer has a release agent which is preferably selected from the group comprising fatty acid metal salts, more preferably zinc stearate or calcium stearate, behenate salts, synthetic waxes, in particular in the form of fatty acid amides, more preferably stearic acid amide and behenic acid amide, fatty acid alkanolamides, more preferably stearic acid methylolamide, paraffin waxes of various melting points, ester waxes of different molecular weights, polyethylene waxes, propylene waxes of different hardnesses, natural waxes, more preferably carnauba wax or montan wax and mixtures thereof.

According to one example, the release agent has a weight proportion of 1 wt. % to 10 wt. % based on the total solids content in the heat-sensitive color-forming layer, the weight proportion preferably being from 3 wt. % to 6 wt. %.

According to one example, the heat-sensitive color-forming layer has an additional pigment, which has the advantage that these additional pigments can fix the chemical melt that is created in the thermal printing process on their surface, and that the surface whiteness and opacity of the heat-sensitive color-forming layer and its printability with conventional printing inks can be controlled via the additional pigments. In addition, the corresponding additional pigments have an “extender function”, for example for the relatively expensive color-producing functional chemicals.

The additional pigment is preferably selected from the group comprising inorganic pigments, both synthetic and natural, precipitated or natural calcium carbonates, clays, aluminum oxides, aluminum hydroxides, silicas, precipitated and pyrogenic silicas, diatomaceous earths, magnesium carbonates, talc, but also organic pigments, more preferably hollow pigments with a styrene/acrylate copolymer wall, urea/formaldehyde condensation polymers and mixtures thereof.

The additional pigment preferably has a weight proportion of 15 wt. % to 50 wt. % based on the total solids content in the heat-sensitive color-forming layer, the weight proportion preferably being from 20 wt. % to 35 wt. %.

According to one example, the heat-sensitive color-forming layer has at least one additional brightener, the additional brightener preferably being selected as a stilbene.

The additional brightener can be used to control the surface whiteness of the heat-sensitive recording material.

According to one example, the heat-sensitive color-forming layer comprises a rheology aid, preferably a thickener and/or a surfactant.

This provides the advantage that certain coating properties of the heat-sensitive color-forming layer can be improved during the manufacturing process.

According to one example, the surface application weight of the heat-sensitive color-forming layer is from 1 g/m² to 10 g/m², preferably from 3 g/m² to 5 g/m².

According to one example, the heat-sensitive color-forming layer has a Bekk smoothness measured according to the ISO 5267:1995-03 standard of 100 sec to 1500 sec, preferably from 200 sec to 750 sec.

According to one example, the surface application weight of the adhesive layer is from 10 g/m² to 150 g/m², preferably from 15 g/m² to 30 g/m².

The above-mentioned object is achieved according to the second aspect by a method for producing a heat-sensitive recording material, comprising the following method steps:
Providing a carrier substrate which has a first side and a second side facing away from the first side;
Applying an application suspension to the first side of the carrier substrate, wherein the application suspension comprises at least one color former, at least one color developer, and at least one stabilizer;
Drying the application suspension in order to obtain a heat-sensitive color-forming layer arranged on the first side of the carrier substrate;
Applying an adhesive layer to the second side of the carrier substrate,
wherein the weight ratio of stabilizer to color developer in the application suspension is selected such that migration of components of the adhesive layer of the heat-sensitive recording material into the heat-sensitive color-forming layer of the heat-sensitive recording material according to the stability test defined in the description after a period of two weeks leads to a remaining image stability of the heat-sensitive color-forming layer of at least 35%,
wherein the stabilizer comprises a compound of formula (I):

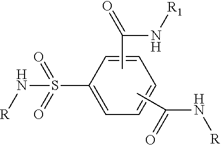

wherein R and R₁ are independently selected from the group comprising hydrogen, C₁-C₁₈-alkyl, C₁-C₈-alkoxy-C₁-C₈-alkyl, and (R₉)₂N—C₁-C₈-alkyl, wherein R₉ is selected from the group comprising C₁-C₈-alkyl, C₅-C₆-cycloalkyl; or a compound of formula (II)

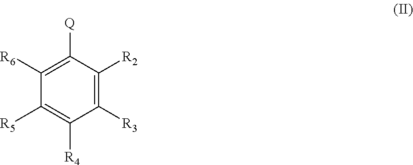

wherein R₂, R₃, R₄, R₅, and R₆ are independently selected from the group comprising hydrogen, C₁-C₈-alkyl, —NH—C(═O)—R₇, or —C(═O)—NH—R₇, wherein R₈ is selected as C₁-C₈-alkyl or —C(═O)OR₃, wherein R₃ is selected as C₁-C₈-alkyl or halogen, or wherein R₂ and R₃, or R₄ and R₅, or both, or wherein R₃ and R₄, or R₅ and R₆, or both, or wherein R₂ and R₃ and R₅ and R₆, together form a hydrocarbon group having three or four carbon atoms, and
wherein Q comprises a single bond or C₁-C₈-alkylene, which may be branched or unbranched, and wherein the C₁-C₈-alkylene comprises a main chain having one or more oxygen atoms between two carbon atoms, if the C₁-C₈ alkylene has more than two carbon atoms;
wherein the at least one color developer comprises a compound of formula (N—I):

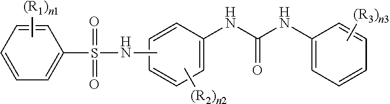

wherein R₁, R₂, and R₃ are independently selected from the group comprising hydrogen, halogen, nitro, C₁-C₆ alkyl, C₁-C₆ alkoxyl, C₂-C₆ alkenyl, C₁-C₆ fluoroalkyl, N(R₄)₂, NHCOR₅, optionally substituted phenyl, and optionally substituted benzyl; wherein R₄ is selected from the group comprising hydrogen, phenyl, benzyl, and C₁-C₆ alkyl, wherein R₅ is selected as C₁-C₆ alkyl, wherein n1 and n3 are independently selected as an integer from 1 to 5, and wherein n2 is an integer from 1 to 4; and/or
wherein the at least one color developer comprises a compound of formula (1):

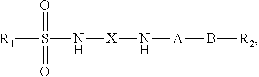

wherein R₁ is selected from the group comprising unsubstituted or substituted phenyl, naphthyl or C₁-C₂₀-alkyl, wherein X is selected from the group comprising —C(═NH)—, —C(═S)— and —C(═O)—, wherein A is selected from the group comprising unsubstituted or substituted phenylene, naphthylene, C₁-C₁₂-alkylene, and an unsubstituted or substituted heterocyclic group, wherein B is selected from the group comprising —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O— PO—(OR₂)₂, and wherein R₂ is selected from the group comprising unsubstituted or substituted aryl, benzyl and C₁-C₂₀-alkyl, with the proviso that if B is not a group of the formula —O—SO₂—, then R₂ is unsubstituted or substituted phenyl, naphthyl or C₁-C₈-alkyl, and that if B is —O—, then R₂ is not alkyl.

The heat-sensitive recording material can be advantageously obtained by the process according to the second aspect.

According to an example, the application of the adhesive layer to the second side of the carrier substrate may involve the application, in particular laminating, of an adhesive film to the second side of the carrier substrate.

According to an alternative example, the application of the adhesive layer to the second side of the carrier substrate can comprise the application of an adhesive dispersion to the second side of the carrier substrate and the subsequent drying of the adhesive dispersion in order to obtain the adhesive layer arranged on the second side of the carrier substrate.

According to an example, the drying of the adhesive layer is carried out at a temperature of 60 °C to 80 °C, preferably at 70 °C.

According to an example, the method has the further method step, which is carried out after the application of the adhesive layer:

Applying a release paper to the adhesive layer, wherein the release paper is preferably designed as a siliconized release paper.

According to an example, the application of the adhesive layer comprises applying an adhesive dispersion and then drying the adhesive dispersion, the method comprising the further method step which is carried out before the application of the adhesive dispersion: Applying a further release paper to the second side of the carrier substrate, the adhesive dispersion being applied to the further release paper.

According to an example, the application and drying of the application dispersion to the first side of the carrier substrate is carried out before the application of the adhesive layer to the second side of the carrier substrate, or the application of the adhesive layer to the second side of the carrier substrate is carried out before the application and drying of the application dispersion to the first side of the carrier substrate, wherein the application and drying of the application dispersion to the first side of the carrier substrate is preferably carried out before the application of the adhesive layer to the second side of the carrier substrate.

According to an example, the application of the application dispersion to the first side of the carrier substrate is carried out by means of curtain coating or by means of a bar doctor on the coating side of a carrier substrate pre-coated with a pigment coating, wherein the pigmented pre-coat preferably comprises calcinated kaolin and a binder based on styrene-butadiene and/or polyvinyl alcohol (PVA) and/or starch, or organic pigments in a mixture with inorganic pigments, wherein the application amount of the pigmented pre-coat is more preferably from 2 g/m² to 12 g/m².

According to an example, the application amount of the application dispersion is between 3 g/m² and 5 g/m², preferably between 3.6 g/m² and 4.8 g/m², and/or the application amount of the adhesive dispersion is between 10 g/m² and 30 g/m², preferably 20 g/m².

According to one example, the application suspension is produced in particular by grinding and preferably has an average grain size D_{(4,3) of} 0.5 μm to 5.0 μm, particularly preferably of 0.50 μm to 1.50 μm and very particularly preferably of 1.5 μm to 2.50 μm.

The examples given for the heat-sensitive recording material according to the first aspect are also examples for the method for producing a heat-sensitive recording material according to the second aspect and vice versa.

The above-mentioned object is achieved according to the third aspect by a heat-sensitive recording material that produceable by a method according to the second aspect.

The examples given for the heat-sensitive recording material according to the first aspect and for the method for producing a heat-sensitive recording material according to the second aspect are also examples for the heat-sensitive recording material produceable by a method according to the third aspect.

The above-mentioned object is achieved according to the fourth aspect the use of at least one stabilizer and at least one color developer in a heat-sensitive recording material, comprising a carrier substrate, which has a first side and a second side facing away from the first side, a heat-sensitive color-forming layer, which is arranged on the first side of the carrier substrate, wherein the heat-sensitive color-forming layer comprises at least one color former, the at least one color developer, and the at least one stabilizer, and an adhesive layer, which is arranged on the second side of the carrier substrate, wherein the adhesive layer comprises at least one adhesive, wherein the weight ratio of stabilizer to color developer in the heat-sensitive color-forming layer is selected such that migration of components of the adhesive layer of the heat-sensitive recording material into the heat-sensitive color-forming layer of the heat-sensitive recording material according to the stability test defined in the description within a period of two weeks results in a remaining image stability of the heat-sensitive color-forming layer of at least 35%,
wherein the stabilizer comprises a compound of formula (I):

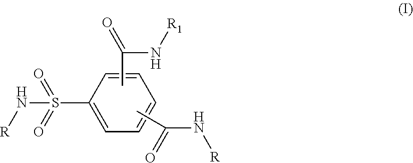

wherein R and R₁ are independently selected from the group comprising hydrogen, C₁-C₁₈-alkyl, C₁-C₈-alkoxy-C₁-C₈-alkyl, and (R₉)₂N—C₁-C₈-alkyl, wherein R₉ is selected from the group comprising C₁-C₈-alkyl, C₅-C₆-cycloalkyl; and a compound of formula (II)

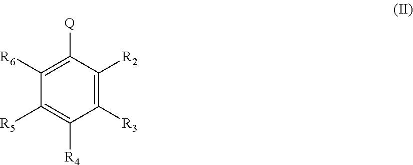

wherein R₂, R₃, R₄, R₅, and R₆ are independently selected from the group comprising hydrogen, C₁-C₈-alkyl, —NH—C(═O)—R₇, and —C(═O)—NH—R₇, wherein R₇ is selected as C₁-C₈-alkyl or —C(═O)OR₈, wherein R₈ is selected as C₁-C₈-alkyl or halogen, or wherein R₂ and R₃, or R₄ and R₅, or both, or wherein R₃ and R₄, or R₅ and R₆, or both, or wherein R₂ and R₃ and R₅ and R₆, together form a hydrocarbon group having three or four carbon atoms, and
wherein Q comprises a single bond or C₁-C₈-alkylene, which may be branched or unbranched, and wherein the C₁-C₈-alkylene comprises a main chain having one or more oxygen atoms between two carbon atoms, if the C₁-C8 alkylene has more than two carbon atoms;
wherein the at least one color developer comprises a compound of formula (N—I):

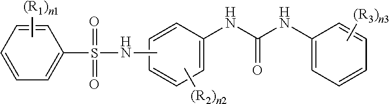

wherein R₁, R₂, and R₃ are independently selected from the group comprising hydrogen, halogen, nitro, C₁-C₆ alkyl, C₁-C₆ alkoxyl, C₂-C₆ alkenyl, C₁-C₆ fluoroalkyl, N(R₄)₂, NHCOR₅, optionally substituted phenyl, and optionally substituted benzyl; wherein R₄ is selected from the group comprising hydrogen, phenyl, benzyl, and C₁-C₆ alkyl, wherein R₅ is selected as C₁-C₆ alkyl, wherein n1 and n3 are independently selected as an integer from 1 to 5, and wherein n2 is an integer from 1 to 4;
and/or wherein the at least one color developer comprises a compound of formula (I):

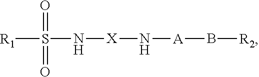

wherein R₁ is selected from the group comprising unsubstituted or substituted phenyl, naphthyl or C₁-C₂₀-alkyl, wherein X is selected from the group comprising —C(═NH)—, —C(═S)— or —C(═O)—, wherein A is selected from the group comprising unsubstituted or substituted phenylene, naphthylene, C₁-C₁₂-alkylenes, and an unsubstituted or substituted heterocyclic group, wherein B is selected from the group comprising —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O— PO—(OR₂)₂, and wherein R₂ is selected from the group comprising unsubstituted or substituted aryl, benzyl and C₁-C₂₀-alkyl, with the proviso that when B is not a group of the formula —O—SO₂—, then R₂ is unsubstituted or substituted phenyl, naphthyl or C₁-C₈-alkyl, and that when B is —O—, then R₂ is not alkyl.

The examples given for the heat-sensitive recording material according to the first aspect and for the method for producing a heat-sensitive recording material according to the second aspect are also examples for the use of at least one stabilizer and at least one color developer in a heat-sensitive recording material according to the fourth aspect.

### EXAMPLES

In the following detailed examples, a large number of heat-sensitive recording materials or thermal papers were produced by applying aqueous application suspensions and adhesive dispersions on a carrier substrate to form a composite structure.

### Production of the Heat-Sensitive Recording Materials

For example, the adhesive dispersion is applied with a doctor blade to the second side formed as the back of a carrier substrate, in particular A4 paper, which carries the color-forming heat-sensitive layer on the first side formed as the front, and dried at a maximum of 70 °C with a hot air dryer in order to obtain the adhesive layer. To protect the adhesive layer in the further processing process, a siliconized release paper is laminated onto the adhesive layer, avoiding air inclusions and wrinkles.

In the case of an “adhesive liner sandwich” consisting of a thin adhesive layer between two release papers, after removing one of the two liner papers, the sticky side of the adhesive layer is laminated onto the second side, which is the back of the carrier substrate, while avoiding air pockets and folds.

It is irrelevant whether, when producing the heat-sensitive recording material, the adhesive layer is first applied to the second side of the carrier substrate and then the heat-sensitive recording layer is applied to the opposite first side of the carrier substrate that carries the adhesive layer, or vice versa.

The application of an aqueous application suspension to form the heat-sensitive color-forming layer of a heat-sensitive recording material is carried out, particularly on a laboratory scale, using a doctor blade on the coating side of a paper pre-coated with a pigment coating with a basis weight of 65 g/m² and 72 g/m².

The composition of the pigmented pre-coat is not critical. In particular, this coating consists of calcinated kaolin and a binder based on styrene-butadiene and/or starch. In particular, pre-coats with organic (hollow sphere) pigments, possibly mixed with inorganic pigments, are also possible. The application quantity of this pigmented layer is between about 2 and 10 g/m².

After the aqueous application suspension of the heat-sensitive coating mass has dried, the heat-sensitive color-forming layer is obtained. The application quantity of the heat-sensitive color-forming layer is between 3.8 g/m² and 4.3 g/m².

By applying an adhesive layer to the opposite back of the substrate carrying the heat-sensitive layer, or the second side of the carrier substrate, a composite material suitable for use as a thermal label is obtained. The application quantity of the adhesive is approximately 20 g/m².

The preparation of the dispersions (each for 1 part by weight) for the application suspensions is described below.

### Color Former Dispersion A:

The color former dispersion A was prepared by grinding 20 parts by weight of 3-N-n-dibutylamine-6-methyl-7-anilinofluorane (ODB-2) with 33 parts by weight of a 12% aqueous solution of Gohsenx™ L-3266 (sulfonated polyvinyl alcohol, Nippon Gohsei) in a bead mill.

### Stabilizer Dispersion B:

The stabilizer dispersion B was prepared by grinding 40 parts by weight of (N-3-methylphenylsulfonylamido)-(N′,N″-bis-{3-methylphenyl)-isophthalic acid diamide (CAS #2375645-78-4, referred to as compound I in the table below) together with 66 parts by weight of a 12% aqueous solution of Gohsenx™ L-3266 (sulfonated polyvinyl alcohol, Nippon Gohsei) in a pearl mill.

### Color Developer Dispersions C:

The aqueous color developer dispersions C were prepared by grinding 40 parts by weight of the respective color developer 4-methyl-N-(((3-(((4-methylphenyl)sulfonyl)oxy)phenyl)amino)carbonyl)benzenesulfonamide (CAS #232938-43-1, α-polymorph, referred to as compound II in the table below), 4-methyl-N-(((3-(((4-methylphenyl)sulfonyl)oxy)phenyl)amino)carbonyl)benzenesulfonamide (CAS #232938-43-1, β-polymorph, referred to as compound Ill in the table below), N-(2-(3-phenylureido)phenyl)benzenesulfonamide (CAS #215917-77-4, α-polymorph, referred to as compound IV in the table below), or N-(2-(3-phenylureido)phenyl)benzenesulfonamide (CAS #215917-77-4, β-polymorph, referred to as compound V in the table below) together with 66 parts by weight of a 12% aqueous solution of Gohsenx™ L-3266 (sulfonated polyvinyl alcohol, Nippon Gohsei) in a bead mill.

### Sensitization Dispersion D:

The sensitization dispersion D was prepared by grinding 40 parts by weight of 1,2-diphenoxyethane with 66 parts by weight of a 12% aqueous solution of Gohsenx™ L-3266 (sulfonated polyvinyl alcohol, Nippon Gohsei) in a pearl mill.

All dispersions A, B, C, and D produced by grinding have an average grain size D_{(4,3)} of 0.7 μm to 1.3 μm. The grain size distribution of the dispersions was measured by laser diffraction using a Coulter LS13320 device from Beckman Coulter.

### Lubricant Dispersion E:

The lubricant dispersion E is a 20% zinc stearate dispersion comprising 9 parts by weight of zinc stearate, 1 part by weight of Gohsenx™ L-3266 (sulfonated polyvinyl alcohol, Nippon Gohsei) and 40 parts by weight of water.

### Pigment P:

The pigment P is a 72% coating kaolin suspension (Lustra® S, BASF).

### Binder Solution:

The binder solution consists of a 10% aqueous polyvinyl alcohol solution (Poval 28-99, Kuraray Europe).

The heat-sensitive application suspension was prepared by mixing while stirring 1 part by weight of the color former dispersion A, 1 part by weight of the stabilizer dispersion B, 1.5 parts by weight of the respective color developer dispersion C, 2.5 parts by weight of the sensitization dispersion D, 1 part by weight of the lubricant dispersion E, 2.1 parts by weight of the pigment P and 2.5 parts by weight of the binder solution, taking into account the order of addition C, D, B, E, P, A, and brought to a solids content of about 25% with water. The application suspension was presented as an example for the color developer-stabilizer ratio of 1.5:1.

The heat-sensitive application suspensions obtained in this way were used to produce composite structures made of a paper carrier and a heat-sensitive color-forming layer.

### Adhesives

In order to produce self-adhesive thermal labels, the following commercially available adhesives were used on the side of the paper carrier facing away from the heat-sensitive color-forming layer, or the second side of the carrier substrate:
R5000N (company Avery Dennison) is a removable adhesive based on acrylate.
S2200 (company Avery Dennison) is a permanently adhesive hot melt adhesive for deep-freeze applications based on styrene-isoprene and PVC copolymers.
Technomelt PS 8746 (company Henkel) is a permanently adhesive hot melt adhesive based on synthetic rubber.

The heat-sensitive recording materials thus obtained, equipped as self-adhesive thermal labels, were tested and evaluated as shown in the table below.

### Measurement of the Optical Density:

6 cm wide strips were obtained from the heat-sensitive recording materials produced in this way, which were thermally printed using a Ge-BE PrinterLab GPT-10000 test printer (company GeBE Elektronik und Feinwerktechnik GmbH, Germany) with a Kyocera print bar of 305 dpi at an applied voltage of 24 V and with a checkerboard pattern at an energy level of 9.00 mJ/mm² and a printing speed of about 100 mm/s. The area of one square of the print pattern corresponds to 80×80 points. The optical density (o.D.) shown in the table below was measured with a SpectroEye densitometer from X-Rite, whereby the measurement uncertainty of the o.D. values is estimated at ≤2%. The scatter of the corresponding calculated % values is ≤±2 percentage points.

### Measurement of the Relative Print Contrast

The relative print contrast was calculated based on the value of the optical density of a thermally printed area (oDₛ) and the optical density of a non-printed area (oD_{w}) according to the following formula B, wherein s stands for a black area and w for a white area:

DK in %=(oDs−oDw/oDs)×100 (Formula B)

### Adhesive Stability Test of Thermal Label Papers

A strip of the heat-sensitive recording material was measured according to the measurement described above and the o.D. before storage was determined. The heat-sensitive recording material was then stored for two or four weeks between two glass plates at 60 °C, a pressure of 1350 N/m², a relative humidity of 50% and in the absence of light.

After the end of the storage period and after the air conditioning to room temperature, the optical densities of the printed (oDs, at an energization energy of 9.00 mJ/mm²) and non-printed (oDw) areas were measured, averaged and used to determine the relative print contrast according to formula B.

Using the optical densities before and after storage at an energization energy of 9.00 mJ/mm², the remaining image stability was determined according to the following formula A:

Image stability in %=(optical density after storage/optical density before storage)×100 (Formula A)

### Evaluation

The table below describes the results of the described image stability and print contrast measurements for a variety of different heat-sensitive recording materials which have a heat-sensitive color on a first side of the carrier substrate and an adhesive layer on the side of the carrier substrate facing away from the first side.

The results obtained in the table are based on the analysis of the image stability and the print contrast of the respective heat-sensitive recording material depending on the migration of components of the adhesive layer into the heat-sensitive color-forming layer, after the corresponding period of two weeks or four weeks.

According to the table, the adhesives of the adhesive layer tested were the previously mentioned R5000N from Avery Dennison, S2200 from Avery Dennison, and Technomelt PS 8746 from Henkel.

According to the table, the compound 5-(N-3-methylphenylsulfonylamido)-(N′,N″-bis-{3-methylphenyl)isophthalic acid diamide (PF425) was investigated as a stabilizer of the heat-sensitive color-forming layer, which is designated as compound I in the table.

According to the table, the compound 4-methyl-N-(((3-(((4-methylphenyl)sulfonyl)oxy)phenyl)amino)carbonyl)benzenesulfonamide (PF-201) was investigated as a color developer of the heat-sensitive color-forming layer, which includes the α-polymorph shown in the table as compound II and β-polymorph as compound Ill.

According to the table, the compound N-(2-(3-phenylureido)phenyl)benzenesulfonamide (NKK-1304) was investigated as a color developer of the heat-sensitive color-forming layer, which includes the α-polymorph as compound IV and β-polymorph as compound V.

The table is shown below.

| | | | TABLE | | | | | | | | | |
|---|---|---|---|---|---|---|---|---|---|---|---|---|
| | | | Adhesive stability test | | | | | | | | | |
| | | | 2-weeks | | | | | 4-weeks | | | | |
| | | | 9.00 mJ/mm² | | | | | 9.00 mJ/mm² | | | | |
| | Weight ratio | | | | | % rel | | | | | % rel. | |
| | of color | | | | % rel | contrast | o.D.w | | | % rel. | contrast | |
| | developer to | | o.D.s | o.D.s | optical | after vs. | more | o.D.s | o.D.s | Optical | after vs. | o.D.w |
| adhesive | stabilizer | | before | after | density | more after | after | before | after | density | more after | after |
| R5000 | 00:01 | (I) | 1.06 | 0.17 | 16 | 65 | 0.06 | 1.06 | 0.11 | 10 | 45 | 0.06 |
| | 01:00 | (II) | 1.39 | 0.36 | 26 | 44 | 0.20 | 1.39 | 0.27 | 19 | 44 | 0.15 |
| | 11:01 | (II:I) | 1.32 | 0.48 | 36 | 69 | 0.15 | 1.32 | 0.29 | 22 | 62 | 0.11 |
| | 07:01 | (II:I) | 1.32 | 0.54 | 41 | 74 | 0.14 | 1.32 | 0.40 | 30 | 75 | 0.10 |
| | 03:01 | (II:I) | 1.29 | 0.56 | 43 | 80 | 0.11 | 1.29 | 0.40 | 31 | 75 | 0.10 |
| | 1.5:1 | (II:I) | 1.27 | 0.62 | 49 | 84 | 0.10 | 1.27 | 0.45 | 35 | 80 | 0.09 |
| | 01:00 | (III) | 1.33 | 0.38 | 29 | 76 | 0.09 | 1.33 | 0.24 | 18 | 50 | 0.12 |
| | 11:01 | (III:I) | 1.30 | 0.49 | 38 | 80 | 0.10 | 1.30 | 0.29 | 22 | 59 | 0.12 |
| | 07:01 | (III:I) | 1.37 | 0.62 | 45 | 84 | 0.10 | 1.37 | 0.41 | 30 | 68 | 0.13 |
| | 03:01 | (III:I) | 1.27 | 0.65 | 51 | 86 | 0.09 | 1.27 | 0.39 | 31 | 72 | 0.11 |
| | 1.5:1 | (III:I) | 1.29 | 0.66 | 51 | 86 | 0.09 | 1.29 | 0.42 | 33 | 74 | 0.11 |
| | 01:00 | (IV) | 1.34 | 0.13 | 10 | 38 | 0.08 | 1.34 | 0.12 | 9 | 25 | 0.09 |
| | 11:01 | (IV:I) | 1.26 | 0.58 | 46 | 86 | 0.08 | 1.26 | 0.36 | 29 | 75 | 0.09 |
| | 07:01 | (IV:I) | 1.28 | 0.67 | 52 | 88 | 0.08 | 1.28 | 0.50 | 39 | 80 | 0.10 |
| | 03:01 | (IV:I) | 1.27 | 0.79 | 62 | 90 | 0.08 | 1.27 | 0.63 | 50 | 86 | 0.09 |
| | 1.5:1 | (IV:I) | 1.24 | 0.89 | 72 | 91 | 0.08 | 1.24 | 0.75 | 60 | 88 | 0.09 |
| | 01:00 | (V) | 1.26 | 0.09 | 7 | 22 | 0.07 | 1.26 | 0.10 | 8 | 20 | 0.08 |
| | 11:01 | (V:I) | 1.28 | 0.21 | 16 | 67 | 0.07 | 1.28 | 0.17 | 13 | 53 | 0.08 |
| | 07:01 | (V:I) | 1.29 | 0.26 | 20 | 73 | 0.07 | 1.29 | 0.20 | 16 | 60 | 0.08 |
| | 03:01 | (V:I) | 1.26 | 0.44 | 35 | 84 | 0.07 | 1.26 | 0.31 | 25 | 74 | 0.08 |
| | 1.5:1 | (V:I) | 1.26 | 0.56 | 44 | 88 | 0.07 | 1.26 | 0.41 | 33 | 80 | 0.08 |
| S2200 | 00:01 | (I) | 1.11 | 0.20 | 18 | 65 | 0.07 | 1.11 | 0.12 | 11 | 33 | 0.08 |
| | 01:00 | (II) | 1.42 | 0.48 | 34 | 56 | 0.21 | 1.42 | 0.29 | 20 | 24 | 0.22 |
| | 11:01 | (II:I) | 1.38 | 0.54 | 39 | 70 | 0.16 | 1.38 | 0.31 | 22 | 52 | 0.15 |
| | 07:01 | (II:I) | 1.34 | 0.63 | 47 | 76 | 0.15 | 1.34 | 0.38 | 28 | 66 | 0.13 |
| | 03:01 | (II:I) | 1.35 | 0.70 | 52 | 79 | 0.15 | 1.35 | 0.44 | 33 | 73 | 0.12 |
| | 1.5:1 | (II:I) | 1.37 | 0.81 | 59 | 84 | 0.13 | 1.37 | 0.48 | 35 | 77 | 0.11 |
| | 01:00 | (III) | 1.39 | 0.45 | 32 | 78 | 0.10 | 1.39 | 0.24 | 17 | 50 | 0.12 |
| | 11:01 | (III:I) | 1.33 | 0.45 | 34 | 78 | 0.10 | 1.33 | 0.28 | 21 | 57 | 0.12 |
| | 07:01 | (III:I) | 1.30 | 0.46 | 35 | 78 | 0.10 | 1.30 | 0.29 | 22 | 59 | 0.12 |
| | 03:01 | (III:I) | 1.31 | 0.69 | 53 | 86 | 0.10 | 1.31 | 0.37 | 28 | 68 | 0.12 |
| | 1.5:1 | (III:I) | 1.36 | 0.68 | 50 | 85 | 0.10 | 1.36 | 0.41 | 30 | 71 | 0.12 |
| | 01:00 | (IV) | 1.35 | 0.17 | 13 | 47 | 0.09 | 1.35 | 0.14 | 10 | 29 | 0.10 |
| | 11:01 | (IV:I) | 1.31 | 0.74 | 56 | 88 | 0.09 | 1.31 | 0.44 | 34 | 77 | 0.10 |
| | 07:01 | (IV:I) | 1.33 | 0.79 | 59 | 89 | 0.09 | 1.33 | 0.55 | 41 | 82 | 0.10 |
| | 03:01 | (IV:I) | 1.33 | 0.96 | 72 | 91 | 0.09 | 1.33 | 0.71 | 53 | 86 | 0.10 |
| | 1.5:1 | (IV:I) | 1.27 | 0.95 | 75 | 91 | 0.09 | 1.27 | 0.77 | 61 | 87 | 0.10 |
| | 01:00 | (V) | 1.38 | 0.10 | 7 | 20 | 0.08 | 1.38 | 0.11 | 8 | 18 | 0.09 |
| | 11:01 | (V:I) | 1.32 | 0.26 | 20 | 65 | 0.09 | 1.32 | 0.17 | 13 | 35 | 0.11 |
| | 07:01 | (V:I) | 1.28 | 0.32 | 25 | 75 | 0.08 | 1.28 | 0.19 | 15 | 47 | 0.1 |
| | 03:01 | (V:I) | 1.25 | 0.48 | 38 | 83 | 0.08 | 1.25 | 0.35 | 28 | 74 | 0.09 |
| | 1.5:1 | (V:I) | 1.25 | 0.62 | 50 | 87 | 0.08 | 1.25 | 0.36 | 29 | 75 | 0.09 |
| Techno | 00:01 | (I) | 1.11 | 0.36 | 32 | 69 | 0.11 | 1.11 | 0.22 | 20 | 50 | 0.11 |
| melt | 01:00 | (II) | 1.42 | 0.57 | 40 | 58 | 0.24 | 1.42 | 0.30 | 21 | 33 | 0.20 |
| | 11:01 | (II:I) | 1.36 | 0.61 | 45 | 69 | 0.19 | 1.36 | 0.42 | 31 | 64 | 0.15 |
| | 07:01 | (II:I) | 1.36 | 0.73 | 54 | 75 | 0.18 | 1.36 | 0.47 | 35 | 66 | 0.16 |
| | 03:01 | (II:I) | 1.38 | 0.77 | 56 | 77 | 0.18 | 1.38 | 0.55 | 40 | 76 | 0.13 |
| | 1.5:1 | (II:I) | 1.34 | 0.77 | 57 | 84 | 0.12 | 1.34 | 0.58 | 43 | 79 | 0.12 |
| | 01:00 | (III) | 1.37 | 0.56 | 41 | 82 | 0.10 | 1.37 | 0.35 | 26 | 60 | 0.14 |
| | 11:01 | (III:I) | 1.24 | 0.58 | 47 | 83 | 0.10 | 1.24 | 0.39 | 31 | 64 | 0.14 |
| | 07:01 | (III:I) | 1.37 | 0.69 | 50 | 86 | 0.10 | 1.37 | 0.46 | 34 | 72 | 0.13 |
| | 03:01 | (III:I) | 1.34 | 0.74 | 55 | 85 | 0.11 | 1.34 | 0.58 | 43 | 76 | 0.14 |
| | 1.5:1 | (III:I) | 1.32 | 0.79 | 60 | 87 | 0.10 | 1.32 | 0.65 | 49 | 80 | 0.13 |
| | 01:00 | (IV) | 1.37 | 0.24 | 18 | 67 | 0.08 | 1.37 | 0.16 | 12 | 38 | 0.10 |
| | 11:01 | (IV:I) | 1.31 | 0.80 | 61 | 89 | 0.09 | 1.31 | 0.65 | 50 | 83 | 0.11 |
| | 07:01 | (IV:I) | 1.29 | 0.88 | 68 | 91 | 0.08 | 1.29 | 0.76 | 59 | 87 | 0.10 |
| | 03:01 | (IV:I) | 1.29 | 0.94 | 73 | 91 | 0.08 | 1.29 | 0.89 | 69 | 89 | 0.10 |
| | 1.5:1 | (IV:I) | 1.25 | 0.93 | 74 | 90 | 0.09 | 1.25 | 0.9 | 72 | 89 | 0.10 |
| | 01:00 | (V) | 1.30 | 0.10 | 8 | 20 | 0.08 | 1.3 | 0.11 | 8 | 9 | 0.10 |
| | 11:01 | (V:I) | 1.30 | 0.41 | 32 | 80 | 0.08 | 1.30 | 0.26 | 20 | 62 | 0.10 |
| | 07:01 | (V:I) | 1.27 | 0.41 | 32 | 80 | 0.08 | 1.27 | 0.32 | 25 | 72 | 0.09 |
| | 03:01 | (V:I) | 1.26 | 0.58 | 46 | 86 | 0.08 | 1.26 | 0.46 | 37 | 80 | 0.09 |
| | 1.5:1 | (V:I) | 1.24 | 0.72 | 58 | 89 | 0.08 | 1.24 | 0.59 | 48 | 85 | 0.09 |

From the results shown in the table, it can be seen that the heat-sensitive recording material according to the present disclosure exhibits the following advantageous properties.

First, it is emphasized that for all adhesives examined (R5000, S2200, and Techno-melt) in the corresponding comparative experiments, the exclusive use of the stabilizer 5-(N-3-methylphenylsulfonylamido)-(N′,N″-bis-{3-methylphenyl)-isophthalic acid diamide (PF425) according to compound I shown in the table without the addition of a corresponding color developer (see compounds II, III, IV, V in the table) only leads to a corresponding extremely low remaining image stability after two weeks, which is therefore not in accordance with the disclosure.

The same applies according to the corresponding comparative experiments for all adhesives examined (R5000, S2200, and Technomelt) also for the exclusive use of the corresponding color developer N-(2-(3-phenylureido)phenyl)benzenesulfonamide (NKK-1304) according to α-polymorph IV shown in the table and β-Polymorph V, and the corresponding color developer 4-methyl-N-(((3-(((4-methylphenyl)sulfonyl)oxy)phenyl)amino)carbonyl)benzenesulfonamide (PF-201) according to the α-Polymorph II and p-Polymorph III shown in the table, without the addition of a corresponding stabilizer of compound I.

For example, when only the α-Polymorph IV or the β-Polymorph V of N-(2-(3-phenylureido)phenyl)benzenesulfonamide (NKK-1304) is added, only a corresponding remaining extremely low image stability of 10% is obtained after two weeks, or 7% when using the adhesive R5000, which is significantly below the limit of the remaining image stability of at least 35% considered sufficient according to the present disclosure.

The same applies to the sole addition of compounds II or Ill, whereby the corresponding remaining extremely low image stability of 26% or 29% is recorded when using the R5000 adhesive after the corresponding period of two weeks.

From the corresponding comparative examples in the table it can be seen that the exclusive use of the stabilizer alone or the respective color developer alone is not sufficient to achieve a remaining image stability of at least 35%, which is considered to be in accordance with the disclosure.

Second, it is emphasized that for all adhesives examined (R5000, S2200, and Technomelt), the inventive combination of stabilizer with at least one color developer in all cases leads to a significant increase in the image stability remaining after the two-week examination period compared to the sole use of stabilizer or color developer.

For example, for the adhesive R5000, when combining the color developer III with the stabilizer I, the image stability remaining after two weeks is between 38% and 51%,
depending on the weight ratio, which image stability is significantly higher than the corresponding image stability when using the stabilizer alone (16%) or compound Ill alone (29%).

A corresponding effect can be seen from the table for all adhesives tested, and for all color developers tested.

Third, it is emphasized that for all adhesives tested (R5000, S2200, and Techno-melt), it was found that an increase in the weight ratio of stabilizer to color developer leads in all cases to a significant increase in the image stability remaining after the test period of two weeks.

For example, for the R5000 adhesive, when combining the color developer IV with the stabilizer I for a weight ratio of 1.5 parts by weight of color developer IV with 1 part by weight of stabilizer I, a remaining image stability of 72% can be obtained after the corresponding period of two weeks, which corresponds to an excellent value.

When using the S2200 adhesive, when combining the color developer IV with the stabilizer I for a weight ratio of 1.5 parts by weight of color developer IV with 1 part by weight of stabilizer I, a remaining image stability of even 75% can be obtained after the corresponding period of two weeks, which corresponds to an extremely excellent value.

A corresponding optimization of the remaining image stability after a period of two weeks based on the optimization of the weight ratio between the respective color developer and the stabilizer can be taken from the table for all adhesives tested and for all color developers tested.

Thus, a synergistic effect in terms of image stability remaining after two weeks can be achieved by combining stabilizer and at least one color developer in the heat-sensitive color-forming layer.

Fourth, it is emphasized that the print contrast remaining after the test period of two weeks is also optimized by optimizing the weight ratio between the respective color developer and the stabilizer.

For example, for the adhesive R5000, when combining the color developer IV with the stabilizer I for a weight ratio of 1.5 parts by weight of color developer IV with 1 part by weight of stabilizer I, a relative print contrast of 91% can be obtained after the corresponding period of two weeks, which corresponds to an excellent value.

A synergistic effect in relation to the print contrast remaining after two weeks can thus be demonstrated by the combination of stabilizer and at least one color developer in the heat-sensitive color-forming layer.

1. A heat-sensitive recording material comprising:
a carrier substrate, which has a first side and a second side facing away from the first side;
a heat-sensitive color-forming layer, which is arranged on the first side of the carrier substrate, wherein the heat-sensitive color-forming layer comprises at least one color former, at least one color developer, and at least one stabilizer; and
an adhesive layer, which is arranged on the second side of the carrier substrate, wherein the adhesive layer comprises at least one adhesive,
wherein a weight ratio of stabilizer to color developer in the heat-sensitive color-forming layer is selected such that migration of components from the adhesive layer into the heat-sensitive color-forming layer according to a stability test after a period of two weeks leads to a remaining image stability of the heat-sensitive color-forming layer of at least 35%,
wherein the stabilizer comprises:
a compound of formula (I): 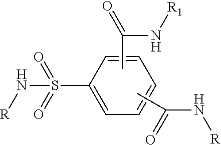
wherein R and R₁ are independently selected from the group comprising hydrogen, C₁-C₁₈-alkyl, C₁-C₈-alkoxy-C₁-C₈-alkyl, and (R₉)₂N—C₁-C₈-alkyl,
wherein R₉ is selected from the group comprising C₁-C₈-alkyl, C₅-C₆-cycloalkyl; or
a compound of formula (II); 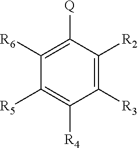
wherein R₂, R₃, R₄, R₅, and R₆ are independently selected from the group comprising hydrogen, C₁-C₈-alkyl, —NH—C(═O)—R₇, and —C(═O)—NH—R₇, wherein R₇ is selected as C₁-C₈-alkyl or —C(═O)OR₈, wherein R₈ is selected as C₁-C₈-alkyl or halogen, or wherein R₂ and R₃, or R₄ and R₅, or both, or wherein R₃ and R₄, or R₅ and R₆, or both, or wherein R₂ and R₃ and R₅ and R₆, together form a hydrocarbon group having three or four carbon atoms, and
wherein Q comprises a single bond or C₁-C₈-alkylene, which is branched or unbranched, and wherein the C₁-C₈-alkylene comprises a main chain having one or more oxygen atoms between two carbon atoms, when the C₁-C₈-alkylene has more than two carbon atoms; and
wherein the at least one color developer comprises a compound of formula (N-I): 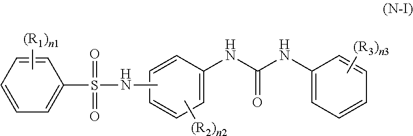
wherein R₁, R₂, and R₃ are independently selected from the group comprising hydrogen, halogen, nitro, C₁-C₆ alkyl, C₁-C₆ alkoxyl, C₂-C₆ alkenyl, C₁-C₆ fluoroalkyl, N(R₄)₂, NHCOR₅, optionally substituted phenyl, and optionally substituted benzyl, wherein R₄ is selected from the group comprising hydrogen, phenyl, benzyl, and C₁-C₆ alkyl, wherein R₅ is selected as C₁-C₆ alkyl, wherein n1 and n3 are independently selected as an integer from 1 to 5, and wherein n2 is an integer from 1 to 4; or
wherein the at least one color developer comprises a compound of formula (1): 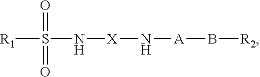
wherein R₁ is selected from the group comprising unsubstituted or substituted phenyl, naphthyl and C₁-C₂₀-alkyl, wherein X is selected from the group comprising —C(═NH)—, —C(═S)— and —C(═O)—, wherein A is selected from the group comprising unsubstituted or substituted phenylene, naphthylene, C₁-C₁₂-alkylene, and an unsubstituted or substituted heterocyclic group, wherein B is selected from the group comprising —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O—PO—(OR₂)₂, and wherein R₂ is selected from the group comprising unsubstituted or substituted aryl, benzyl and C₁-C₂₀-alkyl, wherein when B is not a group of the formula —O—SO2-, then R2 is unsubstituted or substituted phenyl, naphthyl or C1-C8-alkyl, and when B is —O—, then R2 is not alkyl.

2. The heat-sensitive recording material of claim 1, wherein the stabilizer comprises a compound of the formula (Ia): 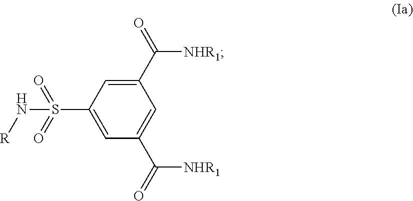
or
wherein the stabilizer comprises a compound of the formula (Ib):

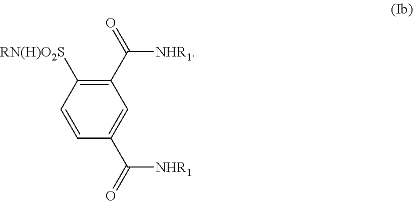

3. The heat-sensitive recording material of claim 1, wherein the stabilizer comprises 5-(N-3-methylphenylsulfonylamido)-(N′,N″-bis-{3-methylphenyl)isophthalic acid diamide.

4. The heat-sensitive recording material of claim 1, wherein the at least one color developer comprises a compound of formula (N-I), and wherein R₁, R₂, and R₃ are selected as hydrogen.

5. The heat-sensitive recording material of claim 1, wherein the at least one color developer comprises N-(2-(3-phenylureido)phenyl)benzenesulfonamide, an α-polymorph or a β-polymorph of N-(2-(3-phenylureido)phenyl)benzenesulfonamide, wherein the α-polymorph is characterized by an X-ray diffraction pattern with Bragg angles (2α/CuKα) of 5.8, 9.3, 13.2, 15.7, 17.3, 18.3, 18.7, 19.5, 20.3, 21.1, 21.9, 22.8, 23.3, 23.6, 24.4, 24.9, 25.6, 26.7, 27.8, 28.1, 29.3, 29.6, 30.2, 31.6, 32.3, 32.8 or a melting point of 158 °C to 159 °C determined by DSC, wherein the β-polymorph is characterized by an X-ray diffraction pattern with Bragg angles (2θ/CuKα) of 10.0, 11.0, 12.3, 12.7, 13.8, 14.9, 15.6, 16.8, 17.7, 18.5, 20.1, 20.9, 21.6, 22.0, 22.8, 23.0, 23.6, 24.3, 25.5, 26.7, 27.8, 28.4, 29.0, 29.8, 30.5, 31.1, 31.3 or a melting point of 173 °C to 174 °C determined by DSC.

6. The heat-sensitive recording material of claim 1, wherein the at least one color developer comprises a compound of formula (I), wherein X is selected as —C(═O)—, wherein R₁ is selected as unsubstituted or substituted phenyl or as C₁-C₃-alkyl substituted phenyl, wherein R₂ is selected as unsubstituted or substituted aryl or unsubstituted phenyl, wherein B is selected as —O—SO₂—, and wherein R₂ is selected as unsubstituted or substituted aryl or as C₁-C₃-alkyl substituted phenyl.

7. The heat-sensitive recording material of claim 1, wherein the at least one color developer comprises 4-methyl-N-(((3-(((4-methylphenyl)sulfonyl)oxy)phenyl)amino)carbonyl)benzenesulfonamide, preferably an α-polymorph or a β-polymorph of 4-methyl-N-(((3-(((4-methylphenyl)sulfonyl)oxy)phenyl)amino)carbonyl)benzenesulfonamide, wherein the α-polymorph is characterized by an X-ray diffraction pattern with Bragg angles (2θ/CuKα) of 8.5, 9.5, 11.8, 12.1, 12.2, 13.7, 14.1, 16.6, 17.1, 18.3, 18.6, 19.1, 19.3, 20.1, 20.4, 20.9, 21.3, 23.1, 24.2, 24.6, 25.0, 27.9, 28.6 or a melting point of 161 °C to 162 °C determined by DSC, wherein the β-polymorph is characterized by an X-ray diffraction pattern with Bragg angles (2θ/CuKα) of 10.3, 11.0, 12.9, 13.2, 15.4, 17.1, 18.0, 18.2, 19.4, 20.0, 20.7, 21.2, 23.0, 24.9, 25.3, 26.5, 26.8, 27.5, 30.7, 32.7 or a melting point of 166 °C to 167 °C determined by means of DSC.

8. The heat-sensitive recording material of claim 1 wherein the weight ratio of stabilizer to color developer in the heat-sensitive color-forming layer is from 1 to 11 to 1 to 1.

9. The heat-sensitive recording material of claim 1, wherein the stabilizer has a weight proportion of 1 wt. % to 10 wt. % based on a total solids content of the heat-sensitive color-forming layer.

10. The heat-sensitive recording material of claim 1, wherein the at least one color developer has a weight proportion of 6 wt. % to 35 wt. % based on a total solids content of the heat-sensitive color-forming layer.

11. The heat-sensitive recording material of claim 1, wherein the image stability of the heat-sensitive color-forming layer remaining after a period of two weeks is at least 40%.

12. The heat-sensitive recording material of claim 1, wherein the at least one adhesive comprises a pressure-sensitive adhesive, a heat-activatable adhesive, or both, wherein the at least one adhesive is a permanently adhesive hot-melt adhesive based on styrene-isoprene and PVC copolymers, or wherein the at least one adhesive is a removable adhesive based on acrylate, or wherein the at least one adhesive is a permanently adhesive hot-melt adhesive based on synthetic rubber.

13. The heat-sensitive recording material of claim 1, wherein the at least one adhesive comprises a permanently adhesive hot melt adhesive based on styrene-isoprene and PVC copolymers, and wherein the weight ratio of stabilizer to color developer in the heat-sensitive color-forming layer is from 1 to 11 to 1 to 1.

14-15. (canceled)

16. The heat-sensitive recording material of claim 1, wherein the at least one adhesive comprises a removable acrylate-based adhesive, and wherein the weight ratio of stabilizer to color developer in the heat-sensitive color-forming layer is from 1 to 11 to 1 to 1.

17-27. (canceled)

28. A method for producing a heat-sensitive recording material, comprising:
providing a carrier substrate, which has a first side and a second side facing away from the first side;
applying an application suspension to the first side of the carrier substrate, wherein the application suspension comprises at least one color former, at least one color developer, and at least one stabilizer;
drying the application suspension, in order to obtain a heat-sensitive color-forming layer arranged on the first side of the carrier substrate;
applying an adhesive layer to the second side of the carrier substrate,
wherein a weight ratio of stabilizer to color developer in the application suspension is selected such that migration of components of the adhesive layer of the heat-sensitive recording material into the heat-sensitive color-forming layer of the heat-sensitive recording material according to a stability test after a period of two weeks leads to a remaining image stability of the heat-sensitive color-forming layer of at least 35%,
wherein the stabilizer comprises;
a compound of formula (I): 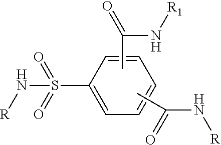
wherein R and R₁ are independently selected from the group comprising hydrogen, C₁-C₁₈-alkyl, C₁-C₈-alkoxy-C₁-C₈-alkyl, and (R₉)₂N—C₁-C₈-alkyl,
wherein R₉ is selected from the group comprising C₁-C₈-alkyl, C₅-C₆-cycloalkyl; or
a compound of formula (II): 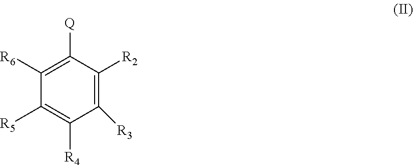
wherein R₂, R₃, R₄, R₅, and R₆ are independently selected from the group comprising hydrogen, C₁-C₈-alkyl, —NH—C(═O)—R₇, or —C(═O)—NH—R₇, wherein R₇ is selected as C₁-C₈-alkyl or —C(═O)OR₈, wherein R₈ is selected as C₁-C₈-alkyl or halogen, or wherein R₂ and R₃, or R₄ and R₅, or both, or wherein R₃ and R₄, or R₅ and R₆, or both, or wherein R₂ and R₃ and R₅ and R₆, together form a hydrocarbon group having three or four carbon atoms, and
wherein Q comprises a single bond or C₁-C₈-alkylene, which is branched or unbranched, and wherein the C₁-C₈-alkylene comprises a main chain having one or more oxygen atoms between two carbon atoms, when the C₁-C₈-alkylene has more than two carbon atoms; and
wherein the at least one color developer comprises a compound of formula (N-I): 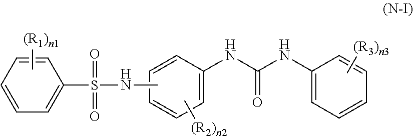
wherein R₁, R₂, and R₃ are independently selected from the group comprising hydrogen, halogen, nitro, C₁-C₆ alkyl, C₁-C₆ alkoxyl, C₂-C₆ alkenyl, C₁-C₆ fluoroalkyl, N(R₄)₂, NHCOR₅, optionally substituted phenyl, and optionally substituted benzyl; wherein R₄ is selected from the group comprising hydrogen, phenyl, benzyl, or C₁-C₆ alkyl, wherein R₅ is selected as C₁-C₆ alkyl, wherein n1 and n3 are independently selected as an integer from 1 to 5, and wherein n2 is an integer from 1 to 4; or
wherein the at least one color developer comprises a compound of formula (1): 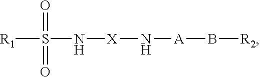
wherein R₁ is selected from the group comprising unsubstituted or substituted phenyl, naphthyl or C₁-C₂₀-alkyl, wherein X is selected from the group comprising —C(═NH)—, —C(═S)— and —C(═O)—, wherein A is selected from the group comprising unsubstituted or substituted phenylene, naphthylene, C₁-C₁₂-alkylene, and a unsubstituted or substituted heterocyclic group, wherein B is selected from the group comprising —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—NH—SO₂—, —NH═CH—, —CO—NH—CO—, —S—, —CO—, —O—, —SO₂—NH—CO—, —O—CO—O— and —O—PO—(OR₂)₂, and wherein R₂ is selected from the group comprising unsubstituted or substituted aryl, benzyl and C₁-C₂₀ alkyl, wherein when B is not a group of the formula —O—SO2-, then R2 is unsubstituted or substituted phenyl, naphthyl or C1-C8-alkyl, and when B is —O—, then R2 is not alkyl.

29. The method of claim 28, wherein drying of the adhesive layer is carried out at a temperature of 60 °C to 80 °C.

30. The method of claim 28, wherein after the application of the adhesive layer, the method further comprises:
applying a release paper or a siliconized release paper to the adhesive layer.

31. The method of claim 28, wherein the application of the adhesive layer comprises applying an adhesive dispersion and a subsequent drying of the adhesive dispersion, wherein before the application of the adhesive dispersion, the method further comprises:
applying a further release paper to the second side of the carrier substrate, wherein the adhesive dispersion is applied to the further release paper.

32. The method of claim 28, wherein the application and drying of the application suspension on the first side of the carrier substrate is carried out before the application of the adhesive layer on the second side of the carrier substrate, or wherein the application of the adhesive layer on the second side of the carrier substrate is carried out before the application and drying of the application suspension on the first side of the carrier substrate, or wherein the application and drying of the application suspension on the first side of the carrier substrate is carried out before the application of the adhesive layer on the second side of the carrier substrate.

33-35. (canceled)

36. A method, comprising:
using at least one stabilizer and at least one color developer in a heat-sensitive recording material, comprising a carrier substrate, which has a first side and a second side facing away from the first side, a heat-sensitive color-forming layer, which is arranged on the first side of the carrier substrate, wherein the heat-sensitive color-forming layer comprises at least one color former, the at least one color developer, and the at least one stabilizer, and an adhesive layer, which is arranged on the second side of the carrier substrate, wherein the adhesive layer comprises at least one adhesive, wherein a weight ratio of stabilizer to color developer in the heat-sensitive color-forming layer is selected such that migration of components of the adhesive layer of the heat-sensitive recording material into the heat-sensitive color-forming layer of the heat-sensitive recording material according to a stability test after a period of two weeks leads to a remaining image stability of the heat-sensitive color-forming layer of at least 35%,
wherein the stabilizer comprises:
a compound of formula (I): 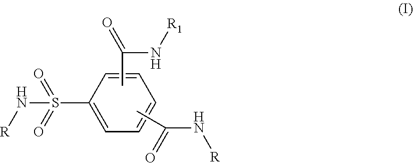
wherein R and R₁ are independently selected from the group comprising hydrogen, C₁-C₁₈-alkyl, C₁-C₈-alkoxy-C₁-C₈-alkyl, and (R₉)₂N—C₁-C₈-alkyl, wherein R₉ is selected from the group comprising C₁-C₈-alkyl, C₅-C₆-cycloalkyl; or
a compound of formula (II): 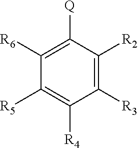
wherein R₂, R₃, R₄, R₅, and R₆ are independently selected from the group comprising hydrogen, C₁-C₈-alkyl, —NH—C(═O)—R₇, and —C(═O)—NH—R₇, wherein R₇ is selected as C₁-C₈-alkyl or —C(═O)OR₈, wherein R₈ is selected as C₁-C₈ alkyl or halogen, or wherein R₂ and R₃, or R₄ and R₅, or both, or wherein R₃ and R₄, or R₅ and R₆, or both, or wherein R₂ and R₃ and R₅ and R₆, together form a hydrocarbon group having three or four carbon atoms, and
wherein Q comprises a single bond or C₁-C₈ alkylene, which is branched or unbranched, and wherein the C₁-C₈ alkylene comprises a main chain having one or more oxygen atoms between two carbon atoms when the C₁-C₈ alkylene has more than two carbon atoms; and
wherein the at least one color developer comprises a compound of formula (N-I): 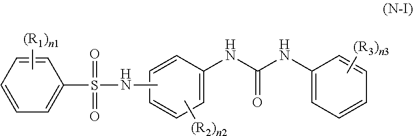
wherein R₁, R₂, and R₃ are independently selected from the group comprising hydrogen, halogen, nitro, C₁-C₆ alkyl, C₁-C₆ alkoxyl, C₂-C₆ alkenyl, C₁-C₆ fluoroalkyl, N(R₄)₂, NHCOR₅, optionally substituted phenyl, and optionally substituted benzyl, wherein R₄ is selected from the group comprising hydrogen, phenyl, benzyl, and C₁-C₆ alkyl, wherein R₅ is selected as C₁-C₆ alkyl, wherein n1 and n3 are independently selected as an integer from 1 to 5, and wherein n2 is an integer from 1 to 4; or
wherein the at least one color developer comprises a compound of formula (1): 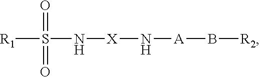
wherein R₁ is selected from the group comprising unsubstituted or substituted phenyl, naphthyl or C₁-C₂₀-alkyl, wherein X is selected from the group comprising —C(═NH)—, —C(═S)— or —C(═O)—, wherein A is selected from the group comprising unsubstituted or substituted phenylene, naphthylene, C₁-C₁₂-alkylenes, and an unsubstituted or substituted heterocyclic group, wherein B is selected from the group comprising —O—SO₂—, —SO₂—O—, —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂, —O—CO—NH—SO₂—, —NH═CH—, —CO—NH—CO—, —S—, —CO—, —O—, —SO₂—NH—CO—, —O—CO—O— and —O—PO—(OR₂)₂, and wherein R₂ is selected from the group comprising unsubstituted or substituted aryl, benzyl and C₁-C₂₀-alkyl, wherein when B is not a group of the formula —O—SO2-, then R2 is unsubstituted or substituted phenyl, naphthyl or C1-C8-alkyl, and when B is —O—, then R2 is not alkyl.
